(19) United States
(12) Patent Application Publication
(10) Pub. No.: US 2018/0295120 A1
(43) Pub. Date: Oct. 11, 2018

(54) SESSION-LIMITED, MANUALLY-ENTERED USER AUTHENTICATION INFORMATION

(71) Applicant: RESCON LTD, CRONDALL (GB)

(72) Inventors: Laura Miranda Dawson, Medstead (GB); Thomas Andrew DAWSON, Medstead (GB)

(21) Appl. No.: 15/914,950

(22) Filed: Mar. 7, 2018

Related U.S. Application Data
(60) Provisional application No. 62/468,359, filed on Mar. 7, 2017.
(60) Provisional application No. 62/541,744, filed on Aug. 6, 2017.

(51) Int. Cl. H04L 29/06; H04L 9/32; H04L 9/08

(52) U.S. Cl. CPC H04L 63/083; H04L 63/108; H04L 9/0866; H04L 9/3213; H04L 9/3242; H04L 63/0861

(57) ABSTRACT

A method for granting access by a user to a computerized system includes first authenticating the user based on initial user authentication information and, every time upon a successful authentication: establishing a session, during which the user is granted the access to the computerized system; saving a resultant based on session-limited user authentication information; and using the saved resultant, during the established session, for authenticating the user for granting subsequent access by the user during the established session based on subsequent user authentication information that is manually entered. The subsequent access may include access following a period of inactivity by the user, or the subsequent access may include access to a sensitive area of the computerized system that is more secure than other areas of the computerized system to which access is granted upon the initial authentication.

### CROSS-REFERENCE TO RELATED APPLICATION

The present application is a nonprovisional patent application of, and claims priority under 35 U.S.C. § 119(e) to, each of U.S. provisional patent application 62/468,359, filed Mar. 7, 2017; and U.S. provisional patent application 62/541,744, filed Aug. 6, 2017. The disclosure of each provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to authentication methodologies for electronic systems, platforms, and resources, which hereinafter are sometimes referred to as “computerized systems”.

Electronic systems, platforms, and resources are becoming more and more ubiquitous every year. While some electronic systems, platforms, and resources are intended to be open to any and all users, and require no authentication, there exist many electronic systems, platforms, and resources where there is a desire to restrict access, e.g., restrict access to certain users.

A very common methodology for restricting access involves the utilization of user credentials that are entered by a user via one or more manual inputs of an electronic apparatus. For example, before a user is provided access, an electronic system, platform, or resource may require a user to type in or otherwise manually provide a password; a passcode; a passphrase; or a personal identification number, i.e., a “PIN”. Other forms of manually-entered user authentication information may comprise a defined pattern of user input, such as performing certain gestures (e.g., swipes) or speaking certain words or phrases; a defined subset of one or more images, such as selecting certain images containing an item from a set of images; or combinations thereof Hereinafter, “manually-entered user authentication information” refers to (i) a password; a passcode; a passphrase; a PIN; a defined pattern of user input, such as performing certain gestures (e.g., swipes) or speaking certain words or phrases; a defined subset of one or more images, such as selecting certain images containing an item from a set of images; or combinations thereof, (ii) that is provided by a user via one or more manual inputs of an electronic apparatus. User credentials also may further comprise an associated identifier—such as a username or user id—that associates such manually-entered user authentication information with a user in a user account. The associated identifier itself may or may not be manually entered.

There is an ongoing struggle between the need to robustly authenticate users, and the need to create systems that are easy to use with minimal barriers to effective implementation. Over time, various technologies have been developed to overcome issues with the creation and recall of manually-entered user authentication information of increasing complexity. Based on the development of such technologies, the death of manually-entered user authentication information was predicted at least as early as fifteen years ago; however, this prediction assumed that alternative methods would be adopted for controlling access to information technology infrastructure, data, and other sensitive areas. Despite this prediction, and the development of various technologies since then, utilization of manually-entered user authentication information has only increased. This increase has been driven by an increase in online services, where manually-entered user authentication information is easy to use and has low implementation costs.

The increase in utilization of manually-entered user authentication information, combined with increasing demand for complexity of such authentication information, has often outstripped the human capacity for memorization and recall of such information. As a result, many users have devised mechanisms to cope with “password” overload, such as reusing the same manually-entered user authentication information across many systems; using simple and predictable creation strategies; and writing down such authentication information (e.g., somewhere where such information might be easily discovered by another individual). All such strategies leave electronic systems, platforms, and resources prone to attack.

Various approaches have been utilized to attempt to discover manually-entered user authentication information. Some of these approaches represent social engineering approaches, e.g., phishing, or coercion. Some approaches involve manual guessing, perhaps using personal information “cribs” such as name, date of birth, or pet names. Another approach involves intercepting manually-entered user authentication information as such information is transmitted over a network. Another approach involves observing someone typing such user authentication information, e.g., “shoulder surfing”. Another approach involves utilizing a key logger to intercept manually-entered user authentication information as it is entered into an electronic apparatus or device (hereinafter simply “electronic apparatus”) using, e.g., a keyboard or keypad. Another approach involves searching an enterprise's information technology infrastructure for the electronic storage of such information. Another approach involves utilizing brute force attacks representing automated guessing until the correct manually-entered user authentication information is tried, which usually involves many guesses. Another approach involves searching for and locating such authentication information where it has been stored insecurely, such as having been handwritten on paper and hidden close to an electronic apparatus that is used to authenticate. Another approach involves compromising a database containing manually-entered user authentication information of many users, and then using such information to attack other systems where the same users may have re-used such authentication information.

There exist a variety of known approaches to overcoming these issues. Some of these approaches are summarized, for example, in the United Kingdom National Cyber Security Centre online guidance. The strategic approaches detailed in that guidance include seven recommendations for system security.

A first of these recommendations relates to changing all default settings for manually-entered user authentication information. This involves, for example, changing all default passwords before deployment, and carrying out a regular check of system devices and software, specifically looking for unchanged default passwords and prioritizing essential infrastructure devices.

A second of these recommendations relates to helping users cope with “password” overload. This can involve, for example, only using passwords where they are really needed; using technical solutions to reduce the burden on users; allowing users to securely record and store their passwords; only asking users to change their passwords on indication or suspicion of compromise; allowing users to reset passwords easily and quickly at low technological implementation costs; and prohibiting password sharing. Password management software also can help users manage manually-entered user authentication information, but use of such software can present their own inherent risks as well.

A third of these recommendations relates to understanding the limitations of manually-entered user authentication information that is user-generated. This can involve, for example, putting technical defenses in place so that simpler password policies can be used, reinforcing policies with good user training, steering users away from choosing predictable passwords, and prohibiting the most common ones by blacklisting. This further can involve, for example, reminding users that work passwords protect important assets and that work passwords should never be used at both work and home. This additionally can involve, for example, making users aware of limitations of password strength meters.

A fourth of these recommendations relates to understanding limitations of manually-entered user authentication information that is machine-generated. This can involve, for example, choosing a scheme that produces passwords that are easier to remember, or offering a choice of passwords, so users can select memorable ones. As with manually-entered user authentication information that is user-generated, users further can be reminded, for example, that work passwords protect access to work-related electronic systems, platforms, and resources and never should be used for protecting access to personal electronic systems, platforms, and resources.

A fifth of these recommendations relates to prioritizing administrator and remote user accounts. This can involve giving administrators, remote users, and mobile devices extra protection. For example, this can involve requiring administrators to use different passwords for their administrative and non-administrative accounts; not routinely granting administrator privileges to standard users; implementing two-factor authentication for all remote accounts; and making sure that no default administrator passwords are used.

A sixth of these recommendations relates to user account lockout and protective monitoring. Account lockout and “throttling” are effective methods of defending brute-force attacks. For example, this can involve allowing a user a limited number of login attempts (e.g., ten) before locking out an account; password blacklisting in combination with lockout or throttling; use of protective monitoring as a defense against brute-force attacks, which can be used alternatively to or additionally with account lockout or throttling; and when outsourcing, requiring that contractual agreements stipulate how user credentials are protected.

A seventh of these recommendations relates to not storing as plain text any manually-entered user authentication information. For example, this can involve producing hashed representations of passwords using a unique salt for each account; storing passwords in a hashed format, produced using a cryptographic function capable of multiple iterations (e.g., SHA 256); and ensuring files containing encrypted or hashed passwords are protected from unauthorized access. This additionally can involve—when implementing password solutions—using public standards, such as PBKDF2, that makes use of multiple iterated hashes.

In order for users to access sensitive data, many organizations require manually-entered user authentication information that is complex, and that is often changed regularly. Unfortunately, this often has the effect of making access less secure rather than more secure. This is because, for example, long and regularly-changing passwords with random characters are difficult to remember, so users tend to write down the passwords and insecurely store them where they can be readily found.

To access sensitive data in more secure electronic platforms and systems, sometimes additional manually-entered user authentication information is required. Such requirement for additional manually-entered user authentication information does not necessarily increase security, as it is yet another piece of information for a user to remember, and a user who has already written down his or her complicated password, for example, is also likely to write down and store his or her second complicated password in proximity to the first, whether physical proximity, or virtual proximity, e.g., within the same electronic document or file.

Many electronic platforms and systems also use tokens as a form of authentication to avoid the requirement that a user repeatedly authenticate using manually-entered user authentication information, e.g., repeatedly “sign in” with a password. An example of this is “open authorization” or OAuth, which is an open standard for token-based authentication and authorization on the Internet. Such a token is stored on a user's system upon successful authentication of a user with manually-entered user authentication information, and thereafter keeps a user “signed in” for a period of time. The token is generated upon the successful authentication using the manually-entered user authentication information, e.g., after a user enters his or her username and password. Because only the token is needed to gain access during the period of time after it has been generated, the username and password are not needed and theft of the token is all that is required for an unauthorized person to gain access during such period of time.

Computer controlled access to electronic platforms and systems, whether virtual or physical, has become increasingly important. This is especially true for the communication, processing, and storage of sensitive materials such as, for example, medical records, and for accessing and controlling critical processes such as, for example, systems for launching missiles and systems for managing nuclear power plants. Due to their high value, these systems, platforms, and resources are often the target of unauthorized access with mal intent. Providing authentication gateways to such a system—or to a sensitive area within a system—is one way of preserving system security and integrity. An “authentication gateway” can be used to verify credentials of a user requesting access to a secure electronic system, platform, or resource, or to a secure area within such an electronic system, platform, or resource.

As described above, many electronic systems, platforms, and resources are designed to gate access using single factor, static authentication requiring a username in conjunction with manually-entered user authentication information, possibly with increased complexity dependent on increased security requirements. Such systems, platforms, and resources have flaws due to difficulties in both generation of complex manually-entered user authentication information and user recall of such authentication information.

Additional solutions have been created to further authenticate a user, such as multi-factor authentication, which requires additional means of authenticating a user, such as a physical or computer readable key (e.g., bank card), or biometrics. Such multi-factor authentication generally includes what a user “knows” (e.g., the manually-entered user authentication information); what a user “possesses” (e.g., a physical device, such as a key card or a smartphone); and who the user “is” (e.g., biometric information). Though these systems are all workable, it is believed that there are areas where security refinements can be made.

One such area involves a problem with static authentication methodologies. By being static, a security system can be prone to a variety of attacks, some of which have been referenced hereinabove. Perhaps based on a recognition of the limitation of static authentication methodologies, some approaches utilize dynamic authentication methodologies. For example, there exist approaches which utilize cryptography and other techniques to create single-session authentication information. An example of this is a “one-time” password. Such a one-time password is valid for only one login session or transaction. Use of dynamic authentication methodologies can address many issues in static authentication methodologies. For example, even if a one-time password is compromised, it will not be effective for authentication after its login session or transaction.

An exemplary system that uses dynamic authentication methodologies is the European web portal “Altinn”, wherein a single session pin is generated by a computer system and sent to a user via the Internet or over a mobile network Short Messaging Service (SMS).

Another system is disclosed in U.S. Patent Application Pub. No. 2014/0282962. This patent publication describes how a trusted communication device may generate and display a single-use user id or password to be utilized for one-time validation of a communication session between an unsecure communication device and a secure communication device.

Another system is disclosed in U.S. Patent Application Pub. No. 2016/0381009, which describes the generation of a one-time passcode by a computer system.

Although securing an initial user authentication is important, there exist various ways that a secure system may be compromised following an initial user login. For example, a user who has logged into a secure system at a device may leave the device without logging out or securing the device, leaving the secure system open to any individual who comes along thereafter and uses the device. One approach that has been utilized to address this type of concern involves the practice of timing out a user from a secure system after a period of non-use, i.e., inactivity. Many secure systems utilize a timeout methodology to prevent unauthorized access to a system that might be left “open” when a user is away. This timeout methodology would then require a user to enter all their credentials again to access the system; however, such a requirement can be considerably disruptive to a user who frequently needs to leave a sensitive system to attend to another task. An example of this is a doctor who enters clinical notes and needs to attend to an urgent patient matter. When the doctor comes back, the timeout may have resulted in the doctor being logged out. Logging back in by authenticating takes time, especially if the manually-entered user authentication information is complex and difficult to remember. The user may even have to retrieve the manually-entered user authentication information from, for example, a notepad in a physically secured location such as a locked cabinet, all of which takes up further time and disrupts workflow.

Additionally, there exist complex systems where different areas of the system, or different pieces of data within the system, have different security levels. An example of this is healthcare management software in which access to sensitive patient data within parts of the system may be required. To access a more secure part of a system, further authentication may be required, which just adds a further requirement on memory or the need to lock a further password physically away, which should be in a separate location from the first.

In view of the foregoing, it is believed that one or more needs continue to exist for improvement in authentication methodologies for electronic systems, platforms, and resources. One or more such needs and other needs are believed to be addressed by one or more aspects and features of the present invention.

### SUMMARY OF THE INVENTION

The present invention includes many aspects and features. Moreover, while many aspects and features relate to, and may be described in, a particular context, the present invention is not limited to use only in such context, as will become apparent from the following summaries and detailed descriptions of aspects, features, and one or more embodiments of the present invention.

Accordingly, in an aspect, a method for granting access by a user to a computerized system comprises authenticating the user based on initial user authentication information. The method further includes, every time upon a successful authentication: establishing a session, during which the user is granted the access to the computerized system; saving a resultant based on session-limited user authentication information; and using the saved resultant, during the established session, for authenticating the user for granting subsequent access by the user during the established session based on subsequent user authentication information that is manually entered. The session-limited user authentication information is manually-entered by the user after the successful authentication that is first performed and is different from the initial user authentication information on which is based the successful authentication that is first performed.

In a feature of this aspect, the resultant comprises the session-limited user authentication information.

In another feature, the resultant comprises the session-limited user authentication information, and an identifier of the user.

In a feature, the resultant comprises a result of a function of the session-limited user authentication information. The function may comprise a hash algorithm, an encryption algorithm, or both a hash algorithm and an encryption algorithm; and the session-limited user authentication information—or a resultant based thereon—may be used as an encryption or decryption key in any such encryption algorithm.

In a feature, the resultant comprises a result of a function of the session-limited user authentication information, wherein the function comprises a mathematical or process-based transformational algorithm or algorithms, or any combination or permutation of algorithms; and the session-limited user authentication information—or a resultant based thereon—may be used as an encryption or decryption key in any such encryption algorithm.

In a feature, the subsequent access that is granted comprises access to the computerized system at a point in time during the established session that is subsequent to a predefined dormant time period in which there is no activity by the user. In this respect, the session may have an expiration time period, after which a new session must be established using the initial user authentication information, and which expiration time period is greater than the dormant time period.

In a feature, the subsequent access that is granted comprises extending a time period of the established session during which the user is granted access to the computerized system.

In a feature, the subsequent access that is granted comprises access to a sensitive area of the computerized system at a point in time during the established session that is subsequent to the user already having been granted and having access to other areas of the computerized system. Further in this respect, every time the user is so authenticated for granting access to the sensitive area of the computerized system, the computerized system may create an entry in a log for use in later auditing access to the sensitive area by that user. The log entry may include the saved resultant.

Insofar as the established session corresponds to the time in which the user is granted access to the computerized system, the subsequent authentication is used to extend or continue the established session during which the user is granted such access. Alternatively, or in addition thereto, insofar as the established session corresponds to the time in which the user is granted access to the computerized system, the subsequent authentication is used to extend access by the user to a sensitive area of such computerized system.

In a feature, each of the initial user authentication information and the session-limited user authentication information is provided by the user, and the security requirements for the initial user authentication information are stricter than the security requirements for the session-limited user authentication information, whereby the initial user authentication information is harder to successfully brute force attack than the session-limited user authentication information. In this respect, the session-limited user authentication information preferably is much easier to recall by a user than the initial user authentication information.

In a feature of this aspect, one or more additional, conventional authentication methodologies are utilized in establishing the session, and the initial user authentication information—when user-generated and manually input—can be of any complexity and, preferably, is much more complex than the manually-entered, session-limited user authentication information.

In a feature, the initial user authentication information comprises a password.

In a feature, the initial user authentication information comprises a passcode.

In a feature, the initial user authentication information comprises a passphrase.

In a feature, the initial user authentication information comprises a personal identification number, i.e., a “PIN”.

In a feature, the initial user authentication information comprises a defined pattern of user input.

In a feature, the initial user authentication information comprises performing certain gestures (physical movements), e.g., swipes on a touchscreen.

In a feature, the initial user authentication information comprises speaking certain words or phrases.

In a feature, the initial user authentication information comprises selecting or identifying a defined subset of one or more images, such as selecting certain images containing an item from a set of images.

In a feature, the initial user authentication information comprises a subset of one or more images.

In a feature, the initial user authentication information comprises two-factor authentication.

In a feature of this aspect, the initial user authentication information comprises biometric information of the user.

In a feature of this aspect, the initial user authentication information comprises a retinal scan or fingerprint scan of the user.

In a feature, the session-limited user authentication information comprises a password.

In a feature, the session-limited user authentication information comprises a passcode.

In a feature, the session-limited user authentication information comprises a passphrase.

In a feature, the session-limited user authentication information comprises a personal identification number, i.e., a “PIN”.

In a feature, the session-limited user authentication information comprises a defined pattern of user input.

In a feature, the session-limited user authentication information comprises performing certain gestures (physical movements), e.g., swipes on a touchscreen.

In a feature, the session-limited user authentication information comprises speaking certain words or phrases.

In a feature, the session-limited user authentication information is secondarily validated by utilizing automated authentication processes such as, but not limited to, biometric scanning, retinal scanning, fingerprint scanning, unique device scanning, facial recognition, voice recognition technologies, and geolocation information, or any combination and permutation of these.

In a feature, the session-limited user authentication information comprises selecting or identifying a defined subset of one or more images, such as selecting certain images containing an item from a set of images.

It will be appreciated that, insofar as the session-limited user authentication information is manually-entered by the user every time upon a successful, initial authentication is first performed—and is different from the initial user authentication information on which is based the successful, initial authentication that is first performed—the session-limited user authentication information is limited to the established session.

At this point it also will be appreciated that, when the session-limited user authentication information is a passcode, such session-limited user authentication information may be referred to as a “session-limited” or “single-session” passcode; when the session-limited user authentication information is a phrase, such session-limited user authentication information may be referred to as a “session-limited” or “single-session” phrase; when the session-limited user authentication information is a password, such session-limited user authentication information may be referred to as a “session-limited” or “single-session” password; and when the session-limited user authentication information is a PIN, such session-limited user authentication information may be referred to as a “session-limited” or “single-session” PIN. The term “SLP” is generally representative of session-limited, manually-entered user authentication information, and means herein any of a session-limited passcode, session-limited phrase, session-limited password, and session-limited PIN.

In a feature, the session-limited user authentication information comprises an SLP.

In another feature, the session-limited user authentication information is temporary.

In another feature, the session-limited user authentication information has an expiration period.

In another feature, the session-limited user authentication information is used only during the established session for authenticating the user during the session for subsequent access to the computerized system.

In another feature of this aspect, the session-limited user authentication information is saved in a transitory medium.

In a feature, the session-limited user authentication information is saved in a cache.

In a feature, the session-limited user authentication information is no longer saved after the established session ends.

In a feature, the session-limited user authentication information is deleted after the established session ends.

In another feature, the saved resultant is used only during the established session for authenticating the user during the session for subsequent access to the computerized system.

In another feature of this aspect, the saved resultant is saved in a transitory medium.

In a feature, the saved resultant is saved in a cache.

In a feature, the saved resultant is no longer saved after the established session ends.

In a feature, the saved resultant is deleted after the established session ends.

In another feature, the saved resultant is temporary.

In another feature, the saved resultant has an expiration period.

In another feature, the session-limited user authentication information is saved in a secure database.

In another feature, the saved resultant is saved in a secure database.

In another feature, the saved resultant comprises a hash of the session-limited user authentication information.

In a feature, the electronic apparatus comprises a desktop computer.

In a feature, the electronic apparatus comprises a laptop computer.

In a feature, the electronic apparatus comprises a phone.

In a feature, the electronic apparatus comprises a tablet.

In a feature, the electronic apparatus comprises a touchscreen device including a touchscreen.

In a feature, the electronic apparatus comprises a smart device such as a smart TV or smart household appliance.

In a feature, the electronic apparatus comprises a device having a processor and limited access functions.

In a feature, the computerized system comprises a cloud platform.

In a feature, the computerized system comprises an online platform.

In a feature, the computerized system comprises a server.

In a feature, the computerized system comprises a database system.

In a feature, the computerized system comprises a medical records system.

In another aspect, a method for granting access by an authorized user to a computerized system comprises the steps of establishing a session, during which initial access to the computerized system is granted, and granting subsequent access to the computerized system during the established session.

In further respect to this aspect, establishing the session comprises: receiving, by the electronic apparatus, by way of one or more inputs associated with the electronic apparatus, initial user authentication information for a computerized system; communicating, from the electronic apparatus, to an authentication service for the computerized system, an initial resultant based on the initial user authentication information; determining, by the authentication service based on the initial resultant, that a user is an authorized user, and consequently returning an initial authentication indication to the electronic apparatus, by which initial authentication indication initial access to the computerized system is granted.

Establishing the session also comprises: displaying, to the authorized user by way of a display associated with the electronic apparatus, an interface soliciting manual entry of session-limited user authentication information; receiving, by the electronic apparatus, by way of one or more manual inputs associated with the electronic apparatus, the session-limited user authentication information; communicating, from the electronic apparatus, to the authentication service, a session-limited resultant based on the session-limited user authentication information; and receiving, by the authentication service, the session-limited resultant and consequently storing an authentication-service resultant based on the session-limited resultant.

Additionally, granting subsequent access to the computerized system during the established session comprises: displaying, by way of the display associated with the electronic apparatus, an interface soliciting manual entry of subsequent user authentication information; receiving, by the electronic apparatus, by way of one or more of the manual inputs associated with the electronic apparatus, the subsequent user authentication information; communicating, from the electronic apparatus, to the authentication service, a subsequent resultant based on the subsequent user authentication information; receiving, by the authentication service, the subsequent resultant and, utilizing the authentication-service resultant and the subsequent resultant, determining that the user is the authorized user and consequently returning a subsequent authentication indication to the electronic apparatus. Granting subsequent access to the computer system also may further comprise receiving, at the electronic apparatus, the subsequent authentication indication, by which subsequent access to the computerized system is granted.

In a feature, the authentication service is part of the computerized system.

In a feature, the authentication service is separate from the computerized system.

In a feature of this aspect, the one or more inputs associated with the electronic apparatus by which the initial user authentication information is received comprises one or more manual inputs. The one or more manual inputs may comprise: a keyboard or keypad; a touchscreen; a microphone; a camera; and combinations thereof. In this feature, the one or more inputs further may comprise one or more non-manual inputs.

In another feature of this aspect, the one or more inputs associated with the electronic apparatus by which the initial user authentication information is received comprises one or more non-manual inputs. The one or more non-manual inputs may comprise: a card reader; a barcode scanner; a transceiver; a fingerprint reader; a retinal scanner; a camera and associated facial-recognition software; and combinations thereof. In this feature, the one or more inputs further may comprise one or more manual inputs.

In a feature, the initial resultant is communicated over a private network.

In a feature, the initial resultant is communicated over the Internet.

In a feature, the initial resultant is communicated in an encrypted form.

In a feature, the initial resultant comprises the initial user authentication information.

In a feature, the initial resultant comprises the initial user authentication information and an identifier of the user, such as a user name or user id.

In a feature, the initial resultant comprises a result of a function of the initial user authentication information, which function is calculated by the electronic apparatus. The function of the initial user authentication information may comprise a hash algorithm; an encryption algorithm; or both a hash algorithm and an encryption algorithm.

In a feature, the session-limited resultant is communicated over a private network.

In a feature, the session-limited resultant is communicated over the Internet.

In a feature, the session-limited resultant is communicated in an encrypted form.

In a feature, the session-limited resultant comprises the session-limited user authentication information.

In a feature, the session-limited resultant comprises the session-limited user authentication information and an identifier of the user, such as a user name or user id.

In a feature, the session-limited resultant comprises a result of a function of the session-limited user authentication information, which function is calculated by the electronic apparatus. The function of the session-limited user authentication information may comprise: a hash algorithm, an encryption algorithm, or both a hash algorithm and an encryption algorithm; and the session-limited user authentication information—or a resultant based thereon—may be used as an encryption or decryption key in any such encryption algorithm.

In a feature, the authentication-service resultant comprises a result of a function of the session-limited resultant.

In a feature, the subsequent resultant is communicated over a private network.

In a feature, the subsequent resultant is communicated over the Internet.

In a feature, the subsequent resultant is communicated in an encrypted form.

In a feature, the subsequent resultant comprises the subsequent user authentication information.

In a feature, the subsequent resultant comprises the subsequent user authentication information and an identifier of the user, such as a user name or user id.

In a feature, the subsequent resultant comprises a result of a function of the subsequent user authentication information, which function is calculated by the electronic apparatus. The function of the subsequent user authentication information may comprise: a hash algorithm, an encryption algorithm, or both a hash algorithm and an encryption algorithm; and the session-limited user authentication information—or a resultant based thereon—may be used as an encryption or decryption key in any such encryption algorithm.

In a feature, the authentication service determines that the user is the authorized user by determining that the result of a function of the subsequent resultant matches the saved authentication-service resultant.

In a feature, after a predefined period of time, access during the established session by the authorized user to the computerized system is denied until it is determined in accordance with the foregoing that a user is the authorized user based on the authentication-service resultant and the subsequent resultant.

In a feature, after a predefined period of time, access during the established session by the authorized user to the computerized system is granted only after it is determined in accordance with the foregoing that a user is the authorized user based on the authentication-service resultant and the subsequent resultant.

In a feature, after a predefined period of inactivity, access during the established session to the computerized system is granted only after it is determined in accordance with the foregoing that a user is the authorized user based on the authentication-service resultant and the subsequent resultant.

In a feature, the subsequent access is granted to a sensitive area of the computerized system during the established session only after it is determined in accordance with the foregoing that a user is the authorized user based on the authentication-service resultant and the subsequent resultant.

In a feature, the authentication service is remote from the electronic apparatus.

In a feature, the authentication service is local to the electronic apparatus, with virtual or close physical separation.

In a feature, the authentication service is local to the electronic apparatus and the access is access to one or more resources of the electronic apparatus. In this regard, such one or more resources of the electronic apparatus comprises access to physical components containing data stored within the electronic apparatus or access to the use of and user interaction with applications run on the electronic apparatus.

In a feature, the computerized system comprises servers, and the authentication service is remote from such servers forming part of the computerized system.

In a feature, the authentication service is local to servers forming part of the computerized system, with virtual or close physical separation.

In a feature, the session is established and maintained by the authentication service.

In a feature, the session is established and maintained by the electronic apparatus.

In a feature, the session is established and maintained by the computerized system.

In a feature, the initial access and the subsequent access to the computerized system is controlled by the electronic apparatus.

In a feature, the initial access and the subsequent access to the computerized system is controlled by the authentication service.

In a feature, the initial access and the subsequent access to the computerized system is controlled by the computerized system.

In a feature, the session-limited user authentication information is utilized for generation of a decryption key.

In another feature, the session-limited resultant is utilized for generation of a decryption key.

In a feature, data is encrypted by the authentication service before communication to the electronic apparatus, and the session-limited user authentication information and/or the session-limited resultant are utilized as a decryption key for decryption of the communicated encrypted data at the electronic apparatus.

In another aspect, a hashed session-limited user authentication information is integrated into a messaging string from a device for information transmitted wirelessly. In a first example of this, a user's weighing scale transmits data to an Android Hub after the user has signed into the user's account and has provided session-limited user authentication information. This session-limited user authentication information then is hashed and incorporated into the messaging string that is transmitted from the device to the main server. It is believed that this helps prevent the threat of a “Man in the Middle” attack through the further authentication using the hashed session-limited user authentication information, which is linked to the time period of the SLP (representing a form of time-based watermarking and validation). In a second example of this, a nurse working in a hospital with a Bluetooth enabled blood pressure cuff scans a patient's barcode, takes blood pressure measurements, and then inputs his or her session-limited user authentication information generated at the nursing station at the start of the day. This verifies that it was the nurse who actually took the blood pressure measurements, further validating the results and providing a check against the time period that the session-limited user authentication information is valid for the nurse.

In another feature, the method further comprises determining that authentication for subsequent access is required.

In a feature, the initial authentication indication comprises an initial authentication token, and the method further comprises the step of storing the initial authentication token at the electronic apparatus. Further in this respect, the initial authentication token may comprise an OAuth token; and the authentication-service resultant may comprise a combination of the initial authentication token and a hash of the session-limited user authentication information, with the session-limited resultant comprising the session-limited user authentication information and with the authentication service calculating the hash of the session-limited user authentication information.

Alternatively, or additionally, the electronic apparatus may calculate the hash of the session-limited user authentication information; and the session-limited resultant may comprise the hash of the session-limited user authentication information, which may be encrypted. Additionally, the session-limited user authentication information of the session-limited resultant may be encrypted.

The subsequent resultant also may comprise a combination of the initial authentication token and a hash of the subsequent user authentication information.

At this point it will be appreciated that, while use of the session-limited user authentication information may not necessarily result in improvement in conventional initial authentication methodologies, use of the session-limited user authentication information does provide an ongoing and easy-to-use single-session authentication mechanism that can be used to prevent a session timeout, as discussed hereinabove, and that can be used to authenticate a user for access to more sensitive areas of a computerized system after general access to the computerized system has been given during an initial authentication for establishing a session, as discussed hereinabove.

In still another feature, the session-limited user authentication information comprises user selected sounds.

In another feature, the session-limited user authentication information comprises user-generated sounds.

In another feature, the session-limited user authentication information comprises a user-generated video clip such as, for example, video clip of a person saying “good morning computer 123” with the face of the person being recorded through the a camera on the electronic apparatus. Such video clip is recognized by the electronic device using a variety of methodologies including, but not limited to, face, voice, tonal, spectroscopic, retinal, iris, and cardiac pattern recognition. The session-limited user authentication information is thereby combined with a biometric signature, insofar as characteristics of the face can be expected to change from day to day, including characteristics such as, for example, skin color through UV exposure, or hair length.

In another feature, the session-limited user authentication information is managed and stored on a local device where that device is the authentication device for another system. That is the session-limited user authentication information is entered into the device and the combination of the device ID and the session-limited user authentication information is used to access the other system. The communication of the combined credentials could be transferred to the system requiring entry through a variety of means including but not limited to physical connection through a docking system or cable, Bluetooth, WiFi connectivity, NFP transfer, interconnectivity, and communications via GPRS, 2G, 3G, 4G, 5G, LTE, and derivatives and evolutions thereof.

In still another feature, session-limited user authentication information is generated by utilizing a specific connectivity method or ID, such as a specific router or physical access point or wireless provider or identifiable cable or docking station, thereby binding the session-limited user authentication information to something.

In another feature, the session-limited user authentication information is preserved on one device until another user logs in. In this way, the session-limited user authentication information can be used for up to an unlimited time period until another user that might share the same device logs in. It is believed that this would only be suitable for low security scenarios in which it is deemed to be more important to preserve the user experience and user accessibility over security.

In another feature, the generation of new session-limited user authentication information is required if there is a detection of a pattern of activity in the computerized system that does not fit with normal patterns of activity. For instance, order of file/folder access or time spent in certain folders or other patterns, such as Internet access and browsing, site or failed password access, and access to other user accounts.

In another aspect, a method for granting access by an authorized user to a computerized system comprises the steps of establishing a session, during which initial access to the computerized system is granted, and granting subsequent access to the computerized system during the established session. In further respect to this aspect, establishing the session comprises: receiving, by the electronic apparatus, by way of one or more inputs associated with the electronic apparatus, initial user authentication information for a computerized system; communicating, from the electronic apparatus, to the computerized system, an initial resultant based on the initial user authentication information; determining, by the computerized system based on the initial resultant, that a user is an authorized user, and consequently returning an initial authentication indication to the electronic apparatus, by which initial authentication indication initial access to the computerized system is granted. Establishing the session also comprises: displaying, to the authorized user by way of a display associated with the electronic apparatus, an interface soliciting manual entry of session-limited user authentication information; receiving, by the electronic apparatus, by way of one or more manual inputs associated with the electronic apparatus, the session-limited user authentication information; communicating, from the electronic apparatus, to the computerized system, a session-limited resultant based on the session-limited user authentication information; and receiving, by the computerized system, the session-limited resultant and consequently storing an authentication resultant based on the session-limited resultant. Additionally, granting subsequent access to the computerized system during the established session comprises: displaying, by way of the display associated with the electronic apparatus, an interface soliciting manual entry of subsequent user authentication information; receiving, by the electronic apparatus, by way of one or more of the manual inputs associated with the electronic apparatus, the subsequent user authentication information; communicating, from the electronic apparatus, to the computerized system, a subsequent resultant based on the subsequent user authentication information; receiving, by the computerized system, the subsequent resultant and, utilizing the authentication resultant and the subsequent resultant, determining that the user is the authorized user and consequently returning a subsequent authentication indication to the electronic apparatus. Granting subsequent access to the computer system also may further comprise receiving, at the electronic apparatus, the subsequent authentication indication, by which subsequent access to the computerized system is granted.

In another aspect, an electronic apparatus comprises a processor; a non-transitory machine-readable memory containing machine-executable instructions that are executable by the processor; a network interface for network communications; an electronic display; and one or more manual inputs. The machine-executable instructions include an application that, when executed, performs a method for granting access by a user to a computerized system comprising: authenticating the user based on initial user authentication information; and every time upon a successful authentication, establishing a session, during which the user is granted the access to the computerized system; saving a resultant based on session-limited user authentication information; and using the saved resultant, during the established session, for authenticating the user for granting subsequent access by the user during the established session. The session-limited user authentication information is received from the user by way of one or more manual inputs after the successful authentication is first performed, and the session-limited user authentication information is not accepted if it is the same as the initial user authentication information on which is based the successful authentication that is first performed.

In another aspect, an electronic apparatus comprises a processor; a non-transitory machine-readable memory containing machine-executable instructions that are executable by the processor; a network interface for network communications; an electronic display; and one or more manual inputs. The machine-executable instructions include an application that, when executed, performs a method comprising: (a) initially, receiving, by the electronic apparatus, initial user authentication information for a computerized system; communicating, using the network interface, from the electronic apparatus to an authentication service, an initial resultant based on the initial user authentication information; receiving back from the authentication service, using the network interface, an initial authentication indication by which initial access to the computerized system is granted to the user; and thereupon displaying, by way of the electronic display, an interface soliciting manual entry of session-limited user authentication information; receiving, by the electronic apparatus, by way of the one or more manual inputs, the session-limited user authentication information; communicating, using the network interface, from the electronic apparatus to the authentication service, a session-limited resultant based on the session-limited user authentication information; and (b) subsequently displaying, by way of the electronic display, an interface soliciting manual entry of subsequent user authentication information; receiving, by the electronic apparatus, by way of one or more of the manual inputs, the subsequent user authentication information; communicating, using the network interface, from the electronic apparatus to the authentication service, a subsequent resultant based on the subsequent user authentication information; receiving back from the authentication service, using the network interface, a subsequent authentication indication by which subsequent access to the computerized system is granted to the user. As part of the prompting, the subsequent user authentication information is not accepted if it is the same as the initial user authentication information on which is based the successful authentication that is first performed, and the user is prompted to enter subsequent user authentication information that is different from the initial user authentication information.

In another aspect, a system comprises: (a) means for authenticating a user based on initial user authentication information; and (b) means for, every time upon a successful authentication, (i) establishing a session, during which the user is granted access to a computerized system; (ii) saving a resultant based on session-limited user authentication information; and (iii) using the saved resultant, during the established session, for authenticating the user for granting subsequent access by the user during the established session based on subsequent user authentication information that is manually entered. The system further includes means for manual entry of the session-limited user authentication information by the user, and means for restricting the session-limited user authentication information to something that is different from the initial user authentication information.

In a feature, the system further comprises means for determining that an event has occurred requiring authentication for subsequent access.

In another aspect, a method comprises: (a) a step for authenticating a user based on initial user authentication information; and (b) steps for, every time upon a successful authentication, (i) establishing a session, during which the user is granted access to a computerized system; (ii) saving a resultant based on session-limited user authentication information; and (iii) using the saved resultant, during the established session, for authenticating the user for granting subsequent access by the user during the established session based on subsequent user authentication information that is manually entered. The method further includes a step for restricting the session-limited user authentication information to something that is different from the initial user authentication information.

Another aspect relates to an electronic device comprising a processor; memory; an electronic display; storage comprising encrypted data from an electronic resource; a portion of a decryption key for the encrypted data received following user login to the electronic resource with first authorization credentials, an application configured to prompt a user for first authorization credentials to login to the electronic resource, and following login to the electronic resource, prompt a user for second temporary authorization credentials to be used for re-authentication for decryption, upon a need to re-authenticate, prompt a user for the second temporary authorization credentials, integrate a hash of newly input second temporary authorization credentials into the stored portion of the decryption key to form a combined decryption key, and utilize the combined decryption key to decrypt the encrypted data.

Another aspect relates to an electronic device comprising a processor; memory; an electronic display; storage comprising an application configured to authorize a user based on input login credentials, prompt a user via the electronic display for temporary authorization credentials, store input temporary authorization credentials, subsequently re-authenticate a user by prompting the user via the electronic display for temporary authorization credentials and comparing newly input temporary authorization credentials to the stored temporary authorization credentials.

Another aspect relates to a system comprising means for first, receiving, from a user via one or more input devices associated with an electronic device, user input corresponding to authorization credentials for an electronic system or platform; communicating, from the electronic device to an authentication service for the electronic system or platform, authentication information for the user based on the input authorization credentials; determining, by the authentication service based on the received authentication information, that the user is an authorized user, and based thereon returning an authorization token to the electronic device; receiving, at the electronic device, the original authorization token, and based thereon storing the received original authorization token at the electronic device and displaying, to the user via a display associated with the electronic device, an interface soliciting entry of a session passcode; receiving, at the electronic device from the user via one or more input devices associated with the electronic device, user input corresponding to entry of a session passcode; integrating a hash of the session passcode into the authentication token, and storing, by the authentication service in a secure data store, the authentication token including the hash of the session passcode integrated therein. The system further comprises means for thereafter, determining that an event has occurred requiring re-authentication of the user; based on the determination that an event has occurred requiring re-authentication of the user, displaying, to the user via a display associated with the electronic device, an interface soliciting entry of the session passcode; receiving, at the electronic device from the user via one or more input devices associated with the electronic device, user input corresponding to entry of a suspect session passcode; integrating a hash of the suspect session passcode into the original authentication token; comparing, by the authentication service, the received authentication token including the hash of the suspect session passcode integrated therein to the stored authentication token including the hash of the session passcode integrated therein and determining that they match; based on the determination that they match, communicating, by the authentication service, a re-authentication indication to the electronic device; and receiving, at the electronic device, the communicated re-authentication indication, and, based thereon, allowing the user continued access to the electronic system or platform.

Another aspect relates to a system comprising means for first, receiving, from a user via one or more input devices associated with an electronic device, user input corresponding to full authorization credentials for an electronic system or platform; communicating, from the electronic device to the electronic system or platform, authentication information for the user based on the input full authorization credentials; determining, by the electronic system or platform based on the received authentication information, that the user is an authorized user, and based thereon returning an authentication indication to the electronic device; receiving, at the electronic device, the authentication indication, and based thereon, displaying, to the user via a display associated with the electronic device, an interface soliciting entry or selection of temporary authentication credentials; receiving, at the electronic device from the user via one or more input devices associated with the electronic device, user input corresponding to entry or selection of temporary authorization credentials; communicating, from the electronic device to the electronic system or platform, an indication of the temporary authorization credentials; storing, by the electronic system or platform at a secure database associated with the electronic system or platform, data corresponding to the temporary authorization credentials. The system further comprises means for thereafter, determining that an event has occurred requiring re-authentication; based on the determination that an event has occurred requiring re-authentication, displaying, to the user via a display associated with the electronic device, an interface soliciting entry of the temporary authorization credentials; receiving, at the electronic device from the user via one or more input devices associated with the electronic device, user input corresponding to entry of suspect temporary authorization credentials; communicating, from the electronic device to the electronic system or platform, an indication of the suspect temporary authorization credentials; comparing, by the electronic system or platform, data corresponding to the suspect temporary authorization credentials to the stored data corresponding to the temporary authorization credentials and determining that they match; based on the determination that they match, communicating, by the electronic system or platform, a re-authentication indication to the electronic device; and receiving, at the electronic device, the communicated re-authentication indication, and, based thereon, allowing the user continued access to the electronic system or platform.

Another aspect relates to a method comprising first, a step for receiving, from a user via one or more input devices associated with an electronic device, user input corresponding to authorization credentials for an electronic system or platform; a step for communicating, from the electronic device to an authentication service for the electronic system or platform, authentication information for the user based on the input authorization credentials; a step for determining, by the authentication service based on the received authentication information, that the user is an authorized user, and based thereon returning an authorization token to the electronic device; a step for receiving, at the electronic device, the original authorization token, and based thereon storing the received original authorization token at the electronic device and displaying, to the user via a display associated with the electronic device, an interface soliciting entry of a session passcode; a step for receiving, at the electronic device from the user via one or more input devices associated with the electronic device, user input corresponding to entry of a session passcode; a step for integrating a hash of the session passcode into the authentication token, and storing, by the authentication service in a secure data store, the authentication token including the hash of the session passcode integrated therein. The method further comprises, thereafter, a step for determining that an event has occurred requiring re-authentication of the user; a step for based on the determination that an event has occurred requiring re-authentication of the user, displaying, to the user via a display associated with the electronic device, an interface soliciting entry of the session passcode; a step for receiving, at the electronic device from the user via one or more input devices associated with the electronic device, user input corresponding to entry of a suspect session passcode; a step for integrating a hash of the suspect session passcode into the original authentication token; a step for comparing, by the authentication service, the received authentication token including the hash of the suspect session passcode integrated therein to the stored authentication token including the hash of the session passcode integrated therein and determining that they match; a step for based on the determination that they match, communicating, by the authentication service, a re-authentication indication to the electronic device; and a step for receiving, at the electronic device, the communicated re-authentication indication, and, based thereon, allowing the user continued access to the electronic system or platform.

Another aspect relates to a method comprising first, a step for receiving, from a user via one or more input devices associated with an electronic device, user input corresponding to full authorization credentials for an electronic system or platform; a step for communicating, from the electronic device to the electronic system or platform, authentication information for the user based on the input full authorization credentials; a step for determining, by the electronic system or platform based on the received authentication information, that the user is an authorized user, and based thereon returning an authentication indication to the electronic device; a step for receiving, at the electronic device, the authentication indication, and based thereon, displaying, to the user via a display associated with the electronic device, an interface soliciting entry or selection of temporary authentication credentials; a step for receiving, at the electronic device from the user via one or more input devices associated with the electronic device, user input corresponding to entry or selection of temporary authorization credentials; a step for communicating, from the electronic device to the electronic system or platform, an indication of the temporary authorization credentials; a step for storing, by the electronic system or platform at a secure database associated with the electronic system or platform, data corresponding to the temporary authorization credentials. The method further comprises, thereafter, a step for determining that an event has occurred requiring re-authentication; a step for based on the determination that an event has occurred requiring re-authentication, displaying, to the user via a display associated with the electronic device, an interface soliciting entry of the temporary authorization credentials; a step for receiving, at the electronic device from the user via one or more input devices associated with the electronic device, user input corresponding to entry of suspect temporary authorization credentials; a step for communicating, from the electronic device to the electronic system or platform, an indication of the suspect temporary authorization credentials; a step for comparing, by the electronic system or platform, data corresponding to the suspect temporary authorization credentials to the stored data corresponding to the temporary authorization credentials and determining that they match; a step for based on the determination that they match, communicating, by the electronic system or platform, a re-authentication indication to the electronic device; and a step for receiving, at the electronic device, the communicated re-authentication indication, and, based thereon, allowing the user continued access to the electronic system or platform.

Another aspect relates to a method comprising first, receiving, from a user via one or more input devices associated with an electronic device, user input corresponding to full authorization credentials; determining, based on the received full authorization credentials, that the user is an authorized user, and based thereon displaying, to the user via a display associated with the electronic device, an interface soliciting entry or selection of temporary authentication credentials; receiving, at the electronic device from the user via one or more input devices associated with the electronic device, user input corresponding to entry or selection of temporary authorization credentials; and securely storing data corresponding to the temporary authorization credentials. The method further comprises, thereafter, determining that an event has occurred requiring re-authentication of the user; based on the determination that an event has occurred requiring re-authentication, displaying, to the user via a display associated with the electronic device, an interface soliciting entry of the temporary authorization credentials; receiving, at the electronic device from the user via one or more input devices associated with the electronic device, user input corresponding to entry of suspect temporary authorization credentials; electronically comparing data corresponding to the suspect temporary authorization credentials to the stored data corresponding to the temporary authorization credentials and determining that they match; and based on the determination that they match, re-authenticating the user.

In still yet another aspect, a method for granting access by a user to a computerized system comprises authenticating the user based on initial user authentication information. The method further includes, following a successful initial authentication for granting the user access to the computerized system: saving a resultant based on session-limited user authentication information that is entered by the user; and using the saved resultant for authenticating the user for granting subsequent access by the user based on subsequent user authentication information that is manually entered. The session-limited user authentication information is different from the initial user authentication information on which is based the successful authentication that is first performed.

In a feature, the session-limited user authentication information is manually entered by the user.

In a feature, the session-limited user authentication information is manually-entered by the user after the successful authentication that is first performed.

In a feature, the session-limited user authentication information is manually entered by the user following the successful initial authentication and, preferably, immediately after the successful initial authentication.

In a feature, the session-limited user authentication information is manually entered by the user with entry of the initial user authentication information.

In a feature, the session-limited user authentication information is not entered by the user before the initial user authentication information is entered.

In a feature, each subsequent access corresponds to a new session during which user access is granted, and the saved resultant is used for a predetermined number of such sessions. In this respect, the session-limited user authentication information on which the saved resultant is based is limited to the predetermined number of subsequent sessions.

In another feature, each subsequent access corresponds to a new session during which user access is granted, and the saved resultant is used for a predetermined period of time following the initial successful authentication. In this respect, the session-limited user authentication information on which the saved resultant is based is limited to use for establishing sessions within this predetermined period of time.

Another aspect relates to one or more computer readable media containing computer executable instructions for performing a disclosed method.

Another aspect relates to a system for performing a disclosed method.

Another aspect relates to a disclosed method.

Another aspect relates to a system in which a disclosed method is performed.

Still additional aspects and features are found in the disclosure of the incorporated U.S. provisional patent application.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combinations thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals.

FIGS. 1-7 illustrate an exemplary methodology in accordance with one or more preferred embodiments.

FIG. 8 illustrates an exemplary interface for accessing a system in accordance with one or more preferred embodiments.

FIGS. 9-12 illustrate an exemplary methodology in accordance with one or more preferred embodiments, wherein a user is required to authenticate utilizing manually-entered subsequent user authentication information upon attempting to access more secure information.

FIGS. 13-14 illustrate an exemplary methodology in accordance with one or more preferred embodiments in which a user is required to authenticate utilizing manually-entered subsequent user authentication information following a period of inactivity, or upon the expiration of an amount of time, since login or the last authentication of the user.

FIGS. 15-17 illustrate an exemplary methodology in accordance with one or more preferred embodiments in which manually-entered subsequent user authentication information is utilized in combination with an authorization token.

FIGS. 18-19 illustrate an exemplary methodology in accordance with one or more preferred embodiments in which a user is required to authenticate utilizing manually-entered subsequent user authentication information.

FIGS. 20-28 illustrates functionality in accordance with one or more preferred embodiments.

FIG. 29 illustrates a system comprising a smartphone in accordance with one or more preferred embodiments.

FIG. 30 illustrates a system comprising a laptop in accordance with one or more preferred embodiments.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or any combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding construction of any claim with sole respect to the United States, no claim element is to be interpreted under 35 U.S.C. § 112(f) unless the explicit phrase “means for” or “step for” is used in such claim element, whereupon this statutory provision is intended to and should apply in the interpretation of such claim element. Regarding any method claim including a condition precedent step, such method requires the condition precedent to be met and the step to be performed at least once during performance of the claimed method.

Furthermore, it is important to note that, as used herein, “a” and “an” each generally denotes “at least one”, but does not exclude a plurality unless the contextual use dictates otherwise. Thus, reference to “a picnic basket having an apple” describes “a picnic basket having at least one apple” as well as “a picnic basket having apples”. In contrast, reference to “a picnic basket having a single apple” describes “a picnic basket having only one apple”.

When used herein to join a list of items, “or” denotes “at least one of the items”, but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”. When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”.

Referring now to the drawings, one or more preferred embodiments of the invention are next described. The following description of one or more preferred embodiments is merely exemplary in nature and is in no way intended to limit the invention, its implementations, or uses.

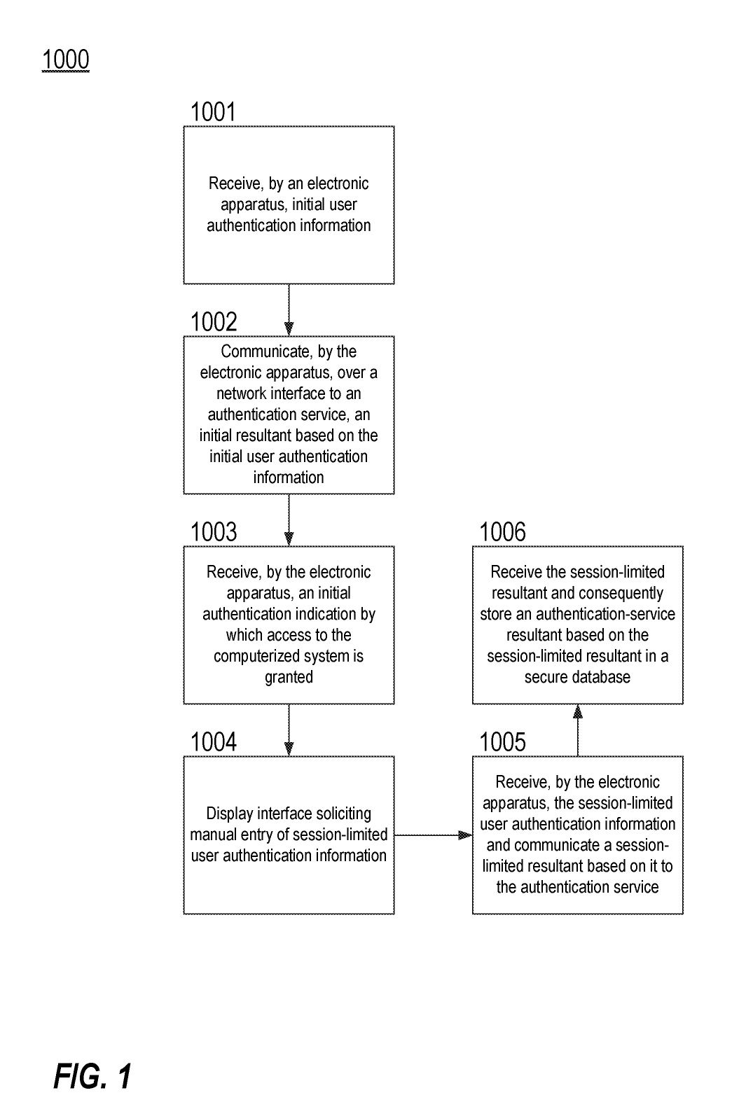

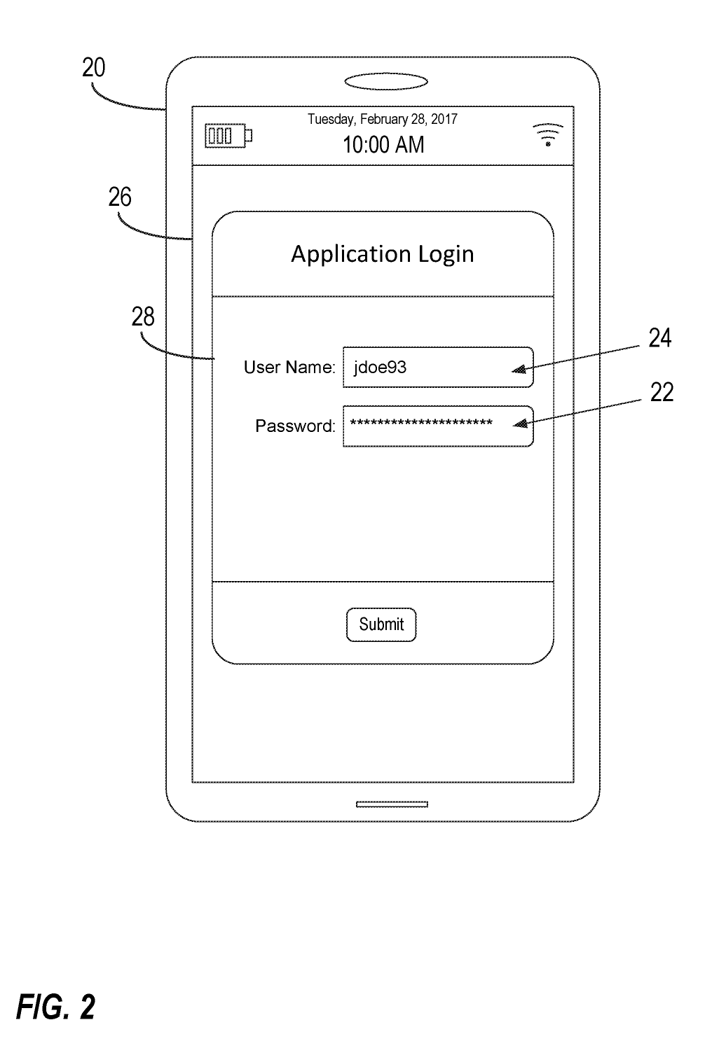

An exemplary methodology 1000 in accordance with one or more preferred embodiments is illustrated in FIG. 1. In accordance with the methodology 1000, initial user authentication information first is received by an electronic apparatus at step 1001. As illustrated in FIG. 2, the electronic apparatus may comprise a smartphone 20; the initial user authentication information may comprise a password that is manually entered via an application login screen at GUI element 22. An identifier of the user comprising a user name also may be entered at GUI element 24. The smartphone 20 includes a touchscreen 26 on which is displayed graphical user interfaces (GUIs) 28—such as a keyboard GUI element—by which information can be manually input. The smartphone alternatively or additionally may include a microphone by which the information is verbally entered by dictation. Furthermore, the initial user authentication information alternatively or additionally may be entered via one or more non-manual inputs.

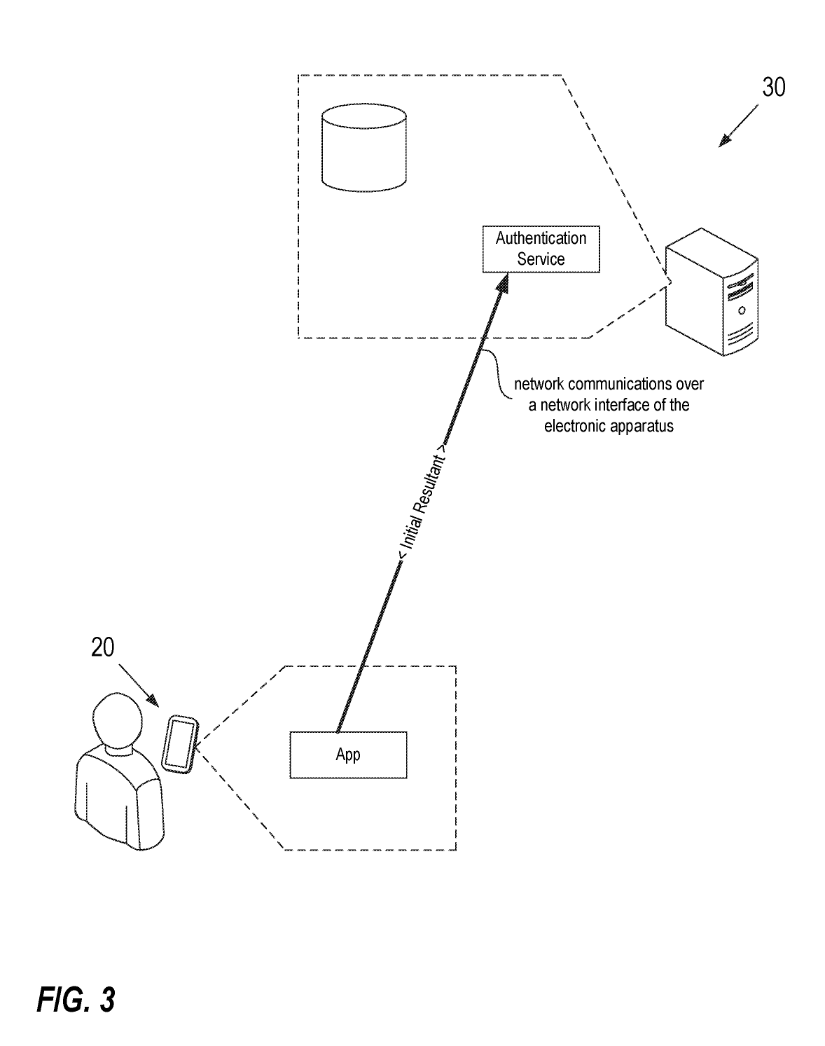

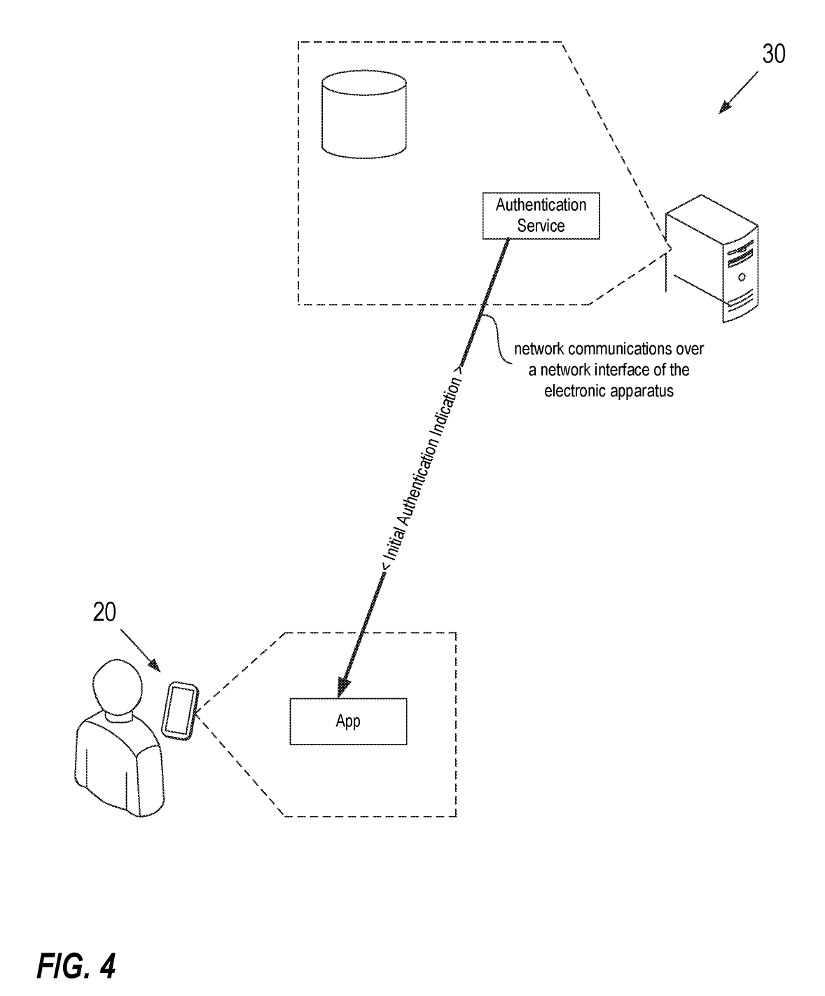

Referring back to FIG. 1, at step 1002 an initial resultant based on the initial user authentication information is communicated from the electronic apparatus to an authentication service for an electronic system, platform, or resource, i.e., a computerized system. This is illustrated in greater detail in FIG. 3, wherein the authentication service 30 utilizes the initial resultant to authenticate the user of the electronic apparatus. Upon determining, by the authentication service based on the initial resultant, that a user is an authorized user, the authentication service consequently returns an initial authentication indication to the electronic apparatus, by which initial authentication indication initial access to the computerized system is granted for an established session. The electronic apparatus receives initial authentication indication at step 1003, which is illustrated in FIG. 4.

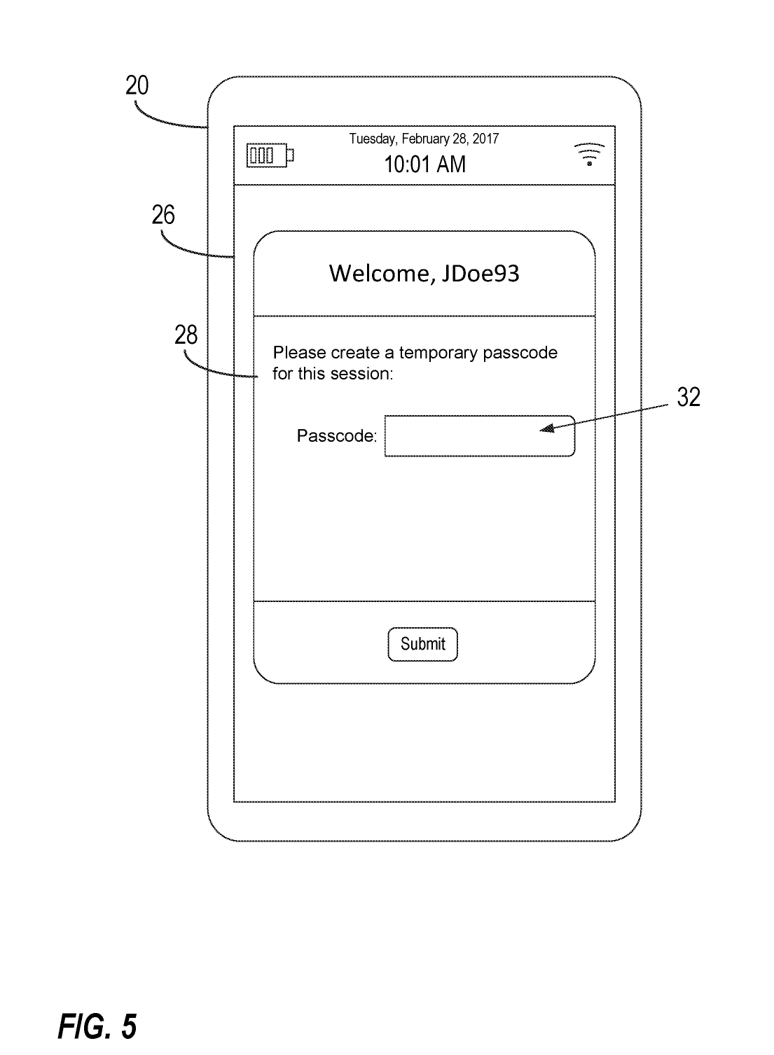

At step 1004, following receipt of the initial authentication indication, an interface soliciting manual entry of session-limited user authentication information is displayed to the authorized user by way of the touchscreen associated with the electronic apparatus. This is illustrated in greater detail in FIG. 5, wherein the touchscreen 26 of the smartphone 20 displays a GUI 28 in which the authorized user is requested to enter at GUI element 32 a temporary passcode for the session.

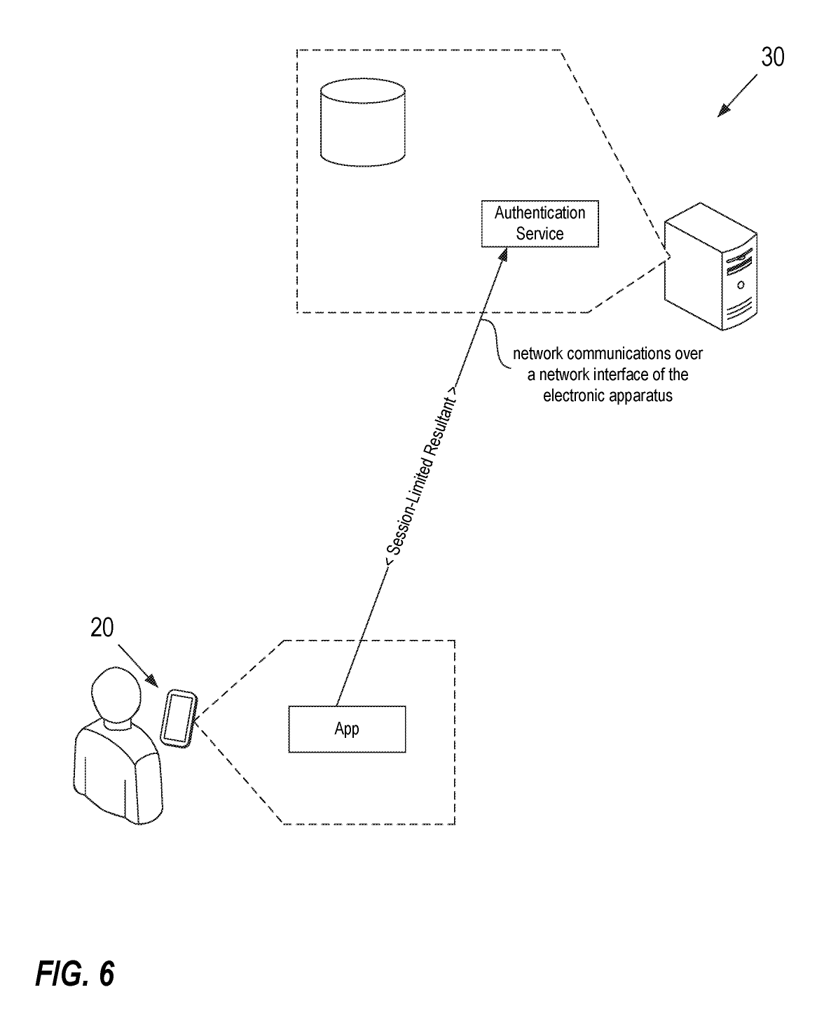

At step 1005, the session-limited user authentication information is received by the electronic apparatus and a session-limited resultant based on it is communicated to the authentication service, which is illustrated in greater detail in FIG. 6.

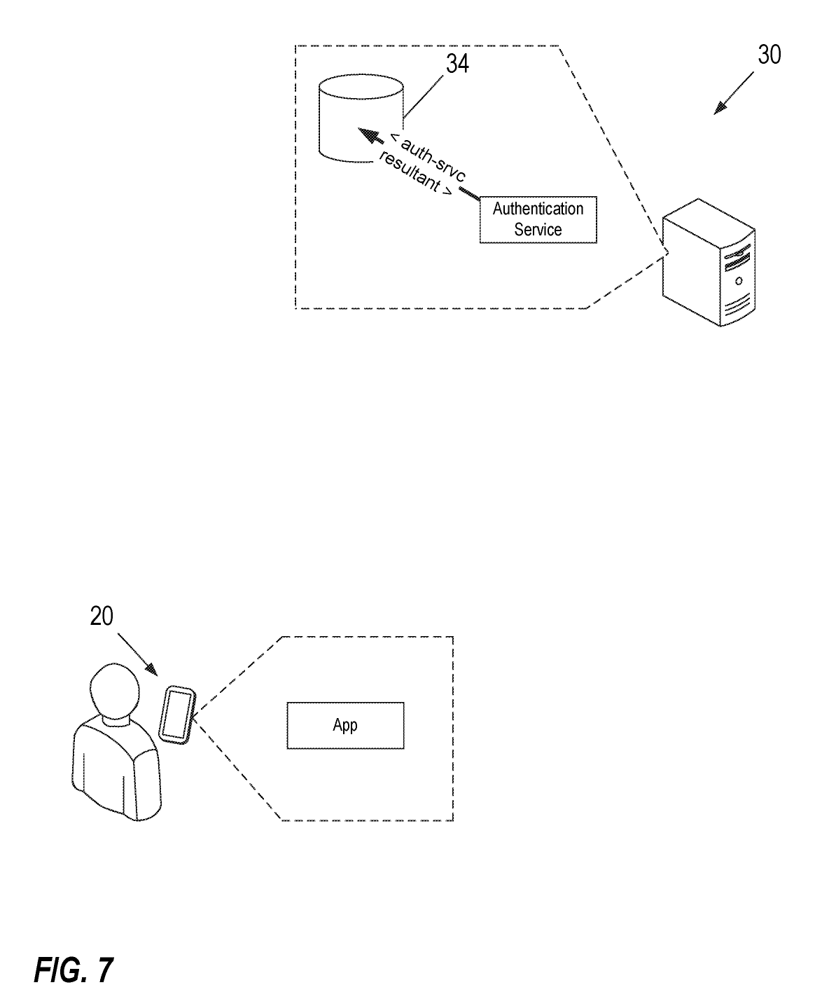

At step 1006, the authentication service 30 receives the session-limited resultant and consequently stores in a secure database 34 an authentication-service resultant based on the session-limited resultant, as illustrated in greater detail in FIG. 7.

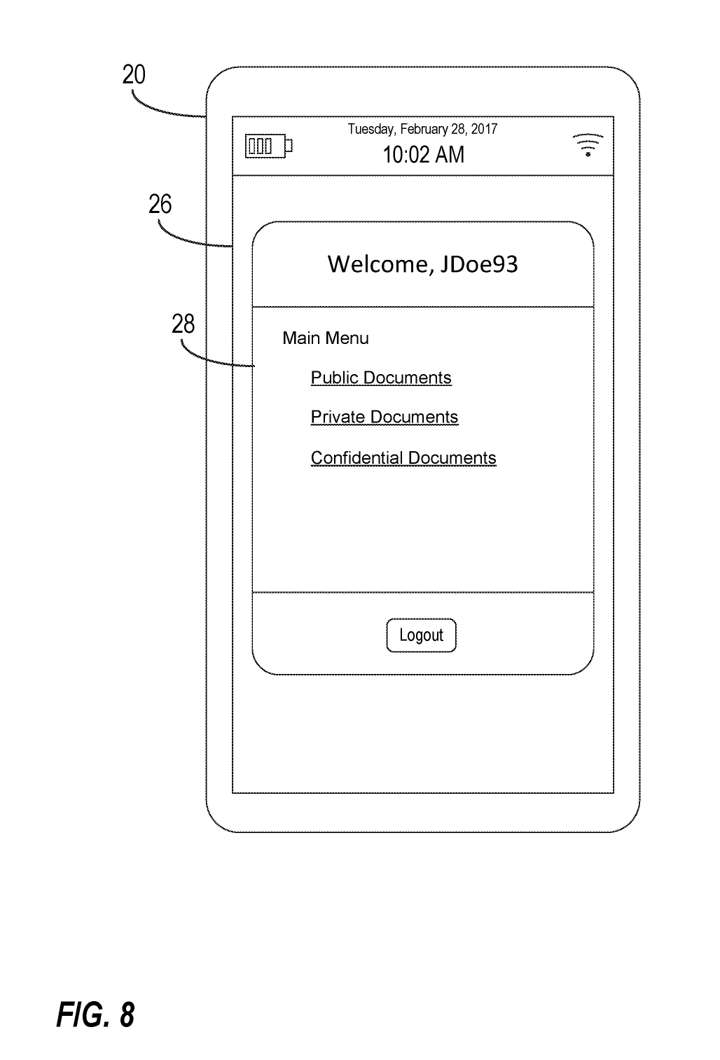

At this point a session has been established during which initial access to the computerized system is granted to the user—the user having been authenticated. Such initial access is represented by the exemplary illustration seen in FIG. 8, wherein the user has access on the electronic apparatus 20 to a computerized document system including a GUI 28 that is displayed on the touchscreen 26 and that relates to a “Main Menu” for selecting “Public Documents”, “Private Documents”, and “Confidential Documents”.

In accordance with one or more preferred embodiments, the user-generated, session-limited user authentication information subsequently can be utilized for rapid re-authentication of the user during the established session. For example, if the user desires to access a particularly secure part of an application or a particularly secure resource, e.g., “confidential” documents as opposed to just “private” documents, then the user can be prompted to re-authenticate using this user-generated, session-limited user authentication information. This allows for subsequent authentication of the user without having to input again the initial user authentication information.

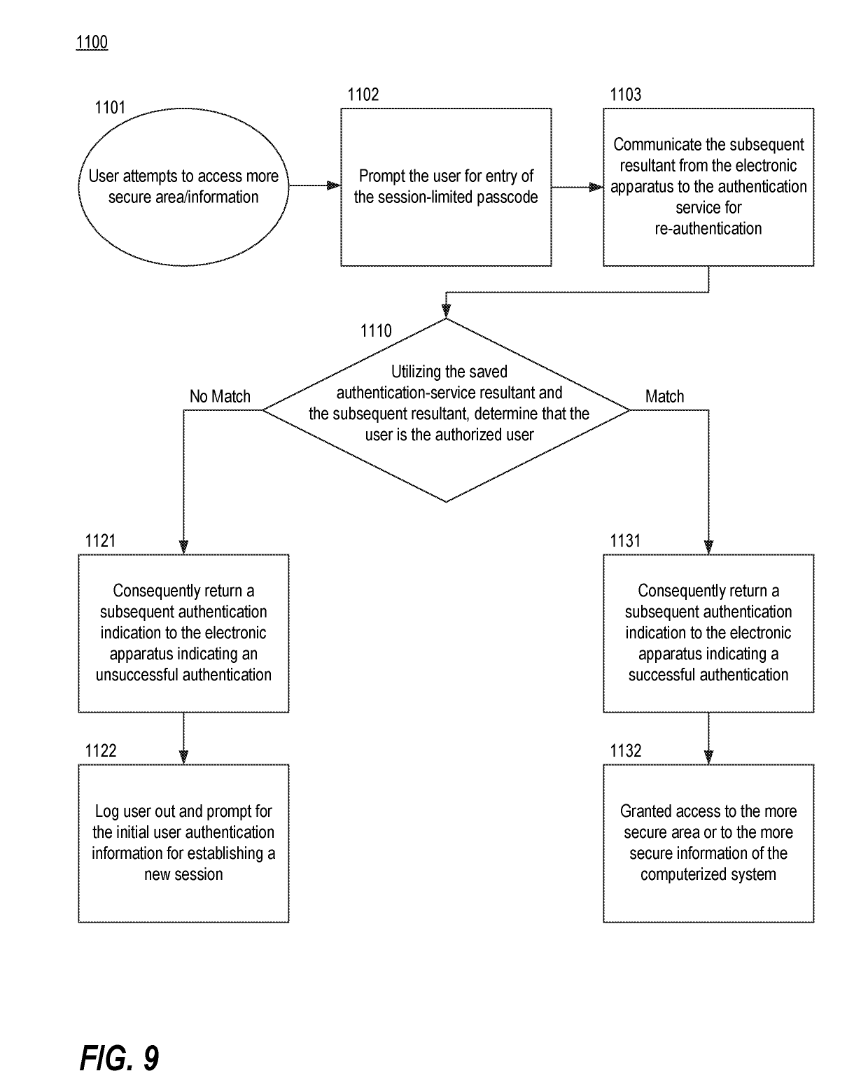

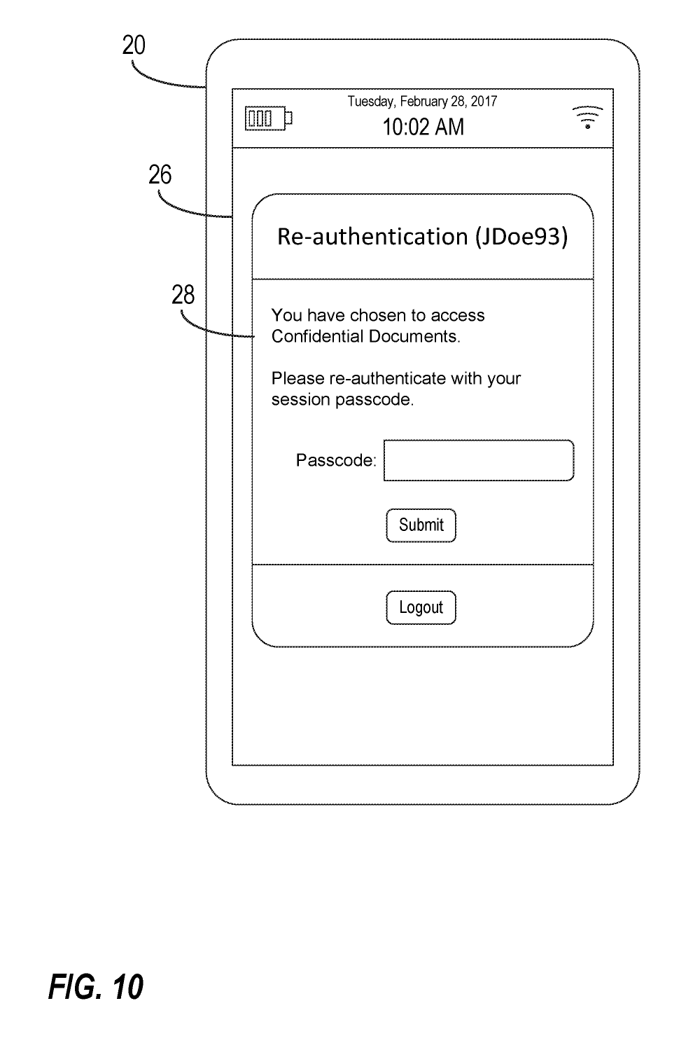

FIG. 9 illustrates an exemplary methodology 1100 in accordance with one or more preferred embodiments in which a user is required to re-authenticate utilizing user-generated, session-limited user authentication information in the form of a session-limited passcode when the user attempts to access more secure information or a more secure area of a computerized system. The attempt occurs at step 1101. In response to this attempt, at step 1102 the user is prompted for entry of the session-limited passcode. This is illustrated in FIG. 10.

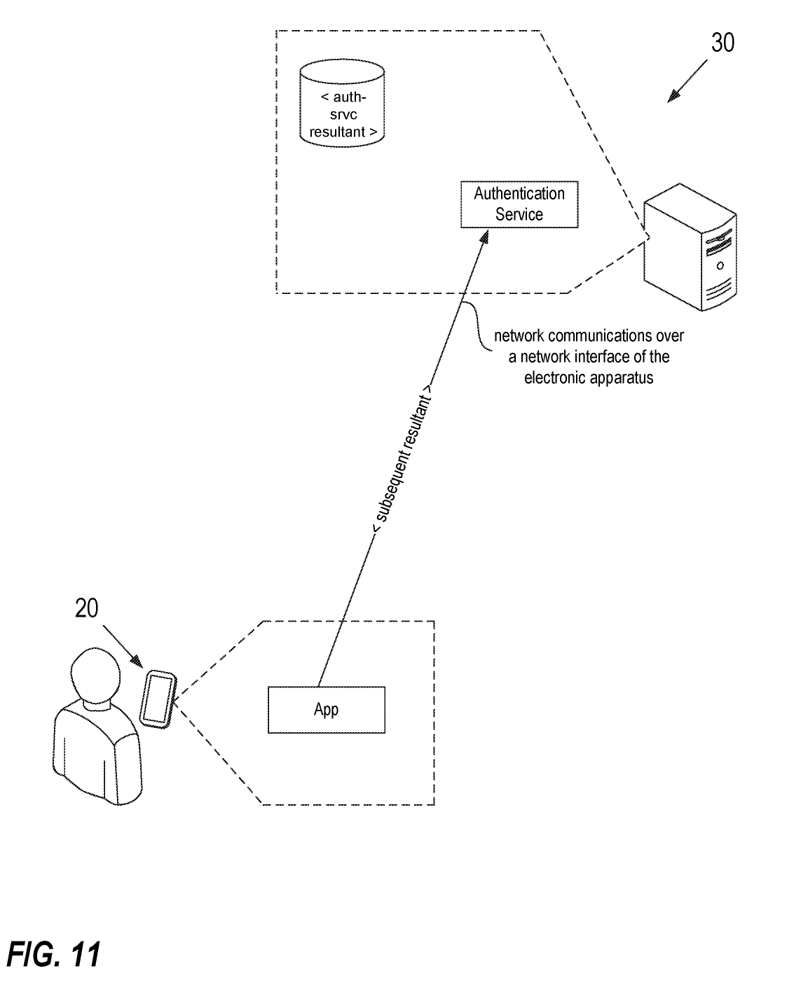

At step 1103, based on the subsequent user authentication information that is entered manually by the user in the form of the input session-limited passcode at step 1102, a subsequent resultant based on the subsequent user authentication information is communicated at step 1103 from the electronic apparatus to the authentication service 30. This is illustrated in FIG. 11.

Next, at step 1110, the authentication service determines that the user is the authorized user based on the saved authentication-service resultant and the subsequent resultant that is received from the electronic apparatus, and consequently a subsequent authentication indication is returned at step 1131 to the electronic apparatus indicating a successful authentication. Thereupon at step 1132 the user is granted access to the more secure area or to the more secure information of the computerized system.

If on the other hand there is no match, then a subsequent authentication indication indicating an unsuccessful authentication is returned to the electronic apparatus, as seen at step 1121. As a consequence of this, at step 1122 the user may be logged out (thereby ending the established session) and prompted to enter the initial user authentication information for establishing a new session.

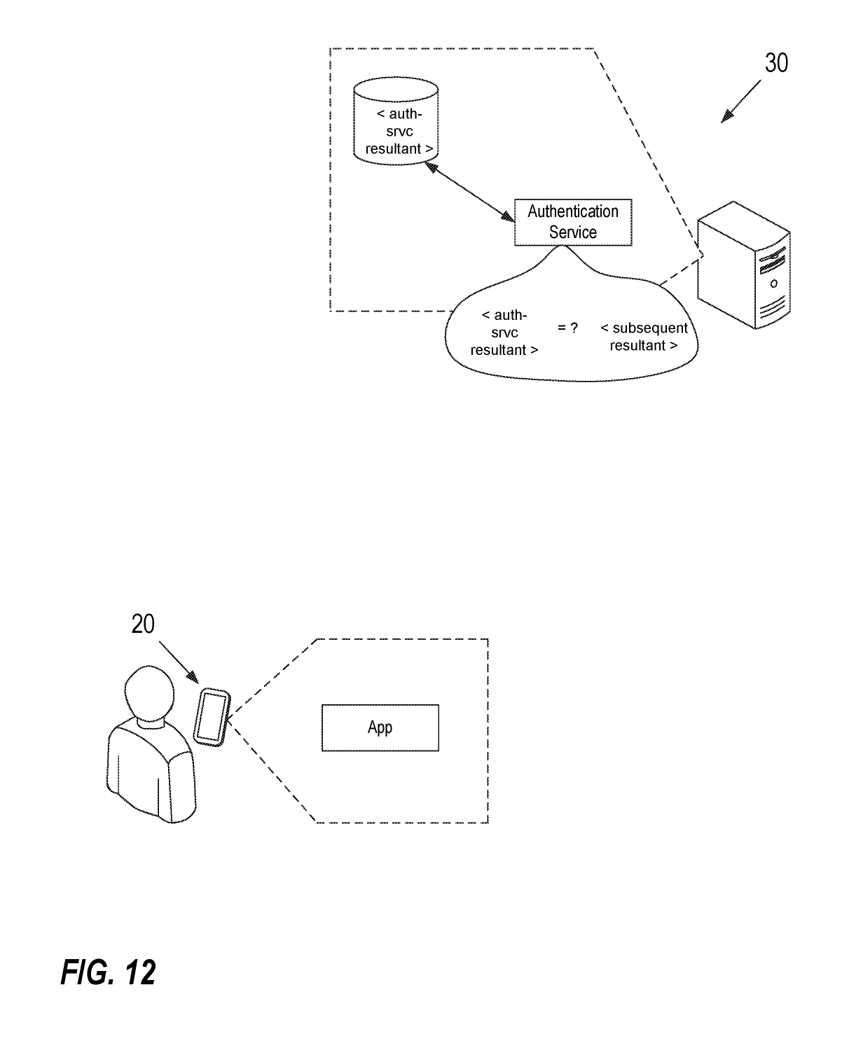

In one or more preferred embodiments, the determination is made by comparing the authentication-service resultant to the subsequent resultant for a match. This comparison for a match in one or more preferred embodiments involves a direct comparison of the received subsequent resultant to the stored authentication-service resultant, as illustrated in FIG. 12. In such implementations, the comparison comprises a hash of the session-limited passcode to a hash of the subsequent user authentication information.

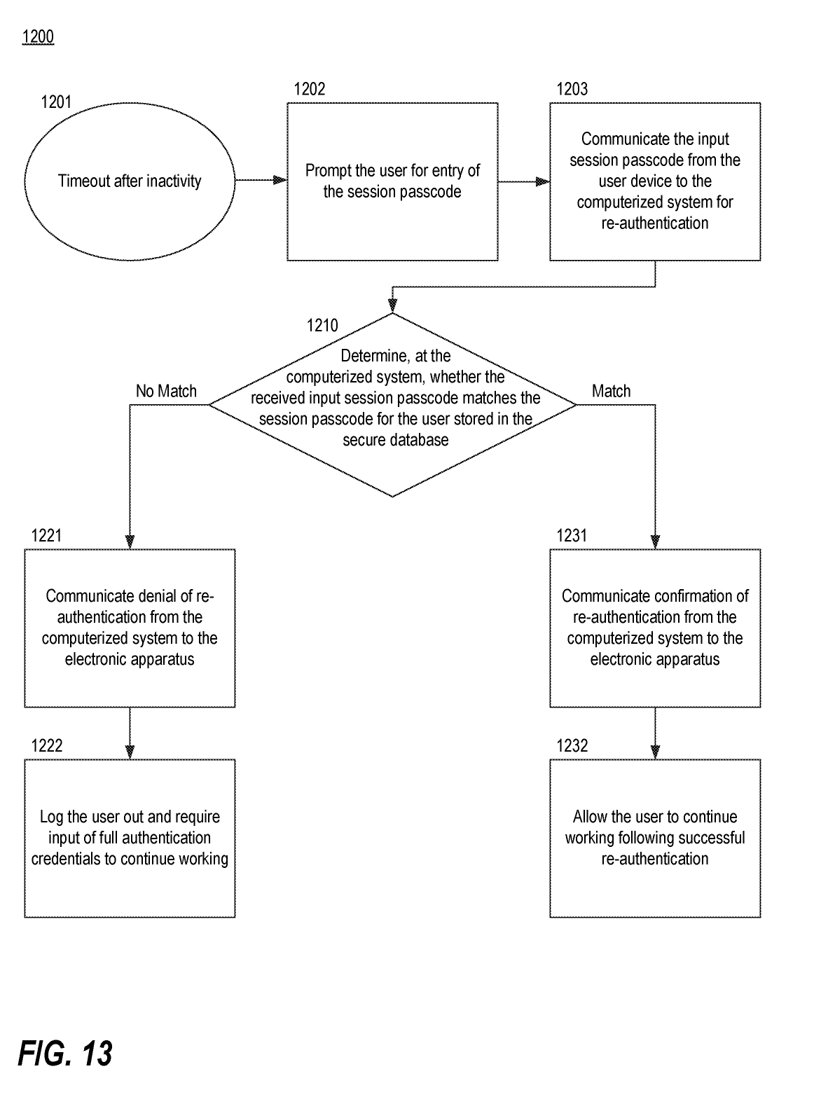

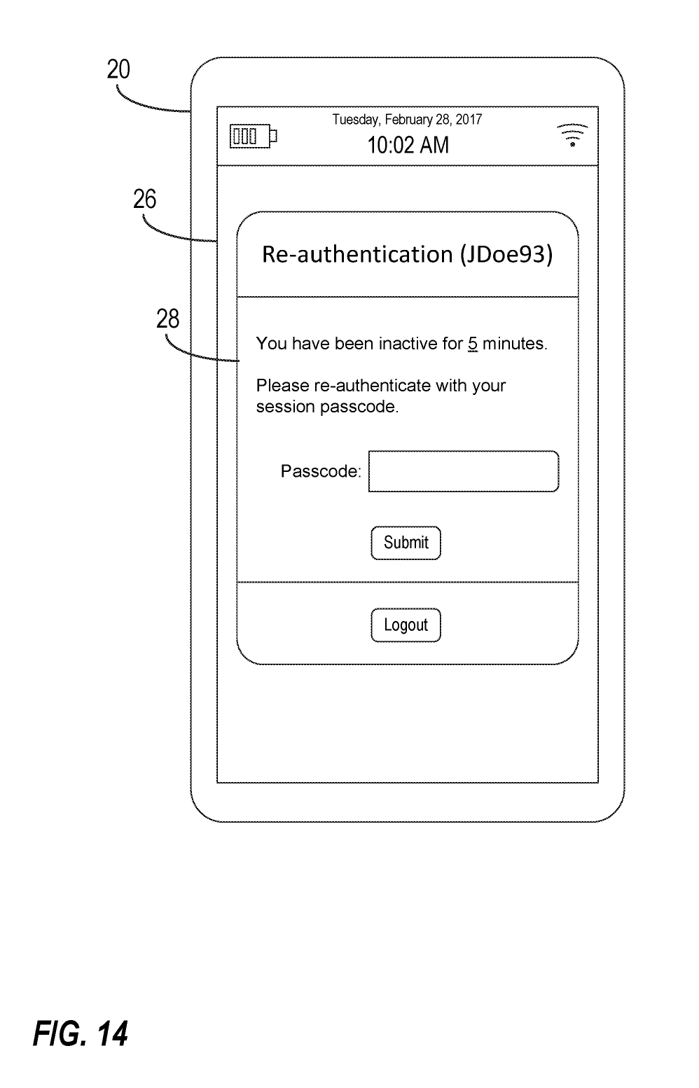

FIG. 13 illustrates another exemplary methodology 1200 in accordance with one or more preferred embodiments in which a user is required to re-authenticate utilizing a user-generated session passcode following a period of inactivity or upon elapsing of an amount of time since login or the last re-authentication (step 1201). Based on this, at step 1202, the user is prompted for entry of the session passcode, as illustrated in FIG. 14.

At step 1203, the input session passcode is communicated from the electronic apparatus to the computerized system for re-authentication (in this implementation, the computerized system performs the authentication service). Next, the computerized system determines whether the received input session passcode is valid for re-authentication of the user. In accordance with one or more preferred embodiments, this involve a direct comparison of the received input session passcode to a stored session passcode, as exemplified by step 1210, while in accordance with one or more preferred embodiments this involves another type of comparison, such as, for example, a comparison of a hash of received input session passcode to a stored hash for a session passcode.

If it is determined that re-authentication is not successful, then at step 1221 an indication of this is communicated from the computerized system to the electronic apparatus, and at step 1222 the user is logged out and/or prompted to re-enter their session passcode and/or full authentication credentials.

If, on the other hand, it is determined that re-authentication is successful, then at step 1231 confirmation of re-authentication is communicated from the computerized system to the electronic apparatus and at step 1232 the user is allowed to continue working.

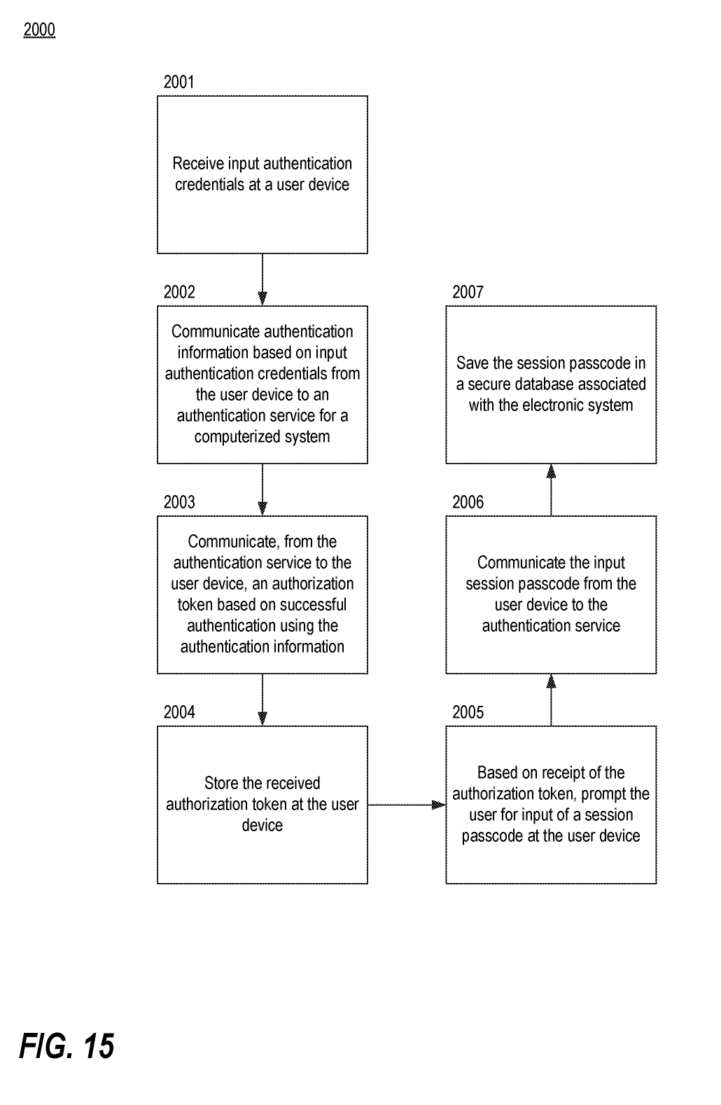

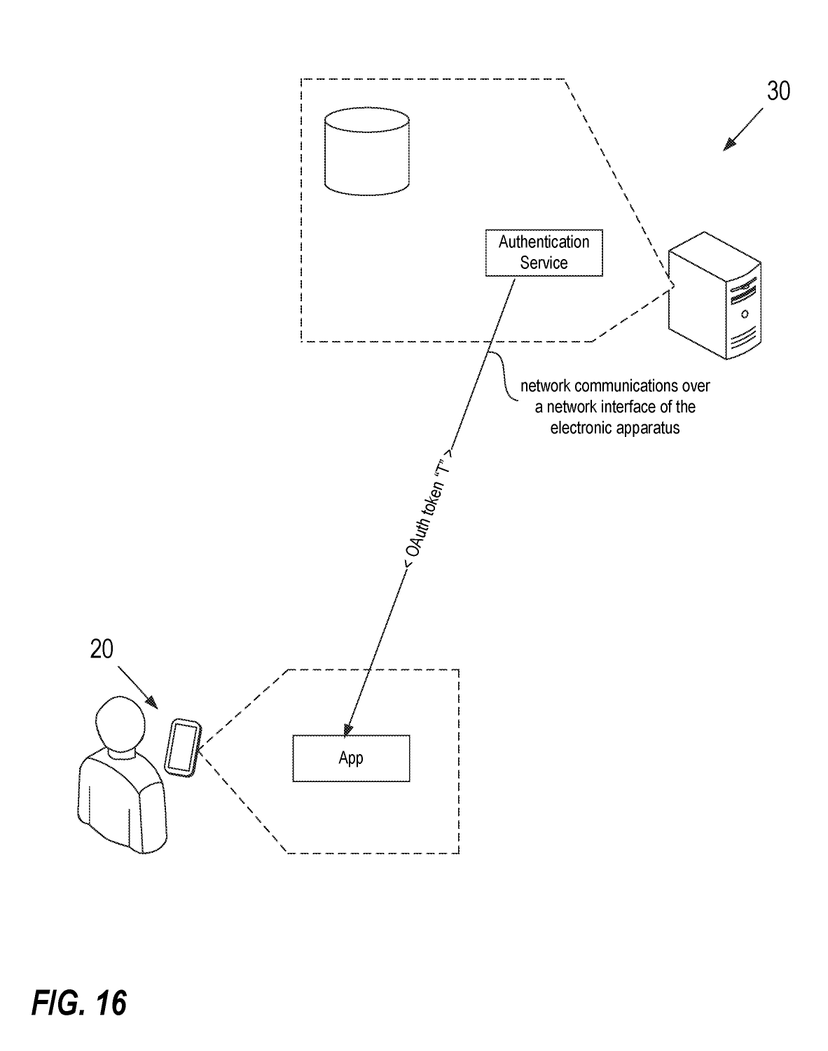

FIG. 15 illustrates an exemplary methodology 2000 in accordance with one or more preferred embodiments in which a session passcode is utilized in combination with an authorization token, such as an OAuth authorization token. In accordance with the methodology 2000, user input representing authentication credentials is first received at an electronic apparatus such as a user device at step 2001. At step 2002, authentication information based on the input authentication credentials is communicated from the electronic apparatus to an authorization service for a computerized system. The authentication service utilizes the received authentication information to authenticate the user of the electronic apparatus, and, provided that the authentication is successful, communicates an authorization token back to the electronic apparatus at step 2003, as illustrated in FIG. 16. The electronic apparatus receives this authorization token and, at step 2004, stores the received authorization token at the electronic apparatus.

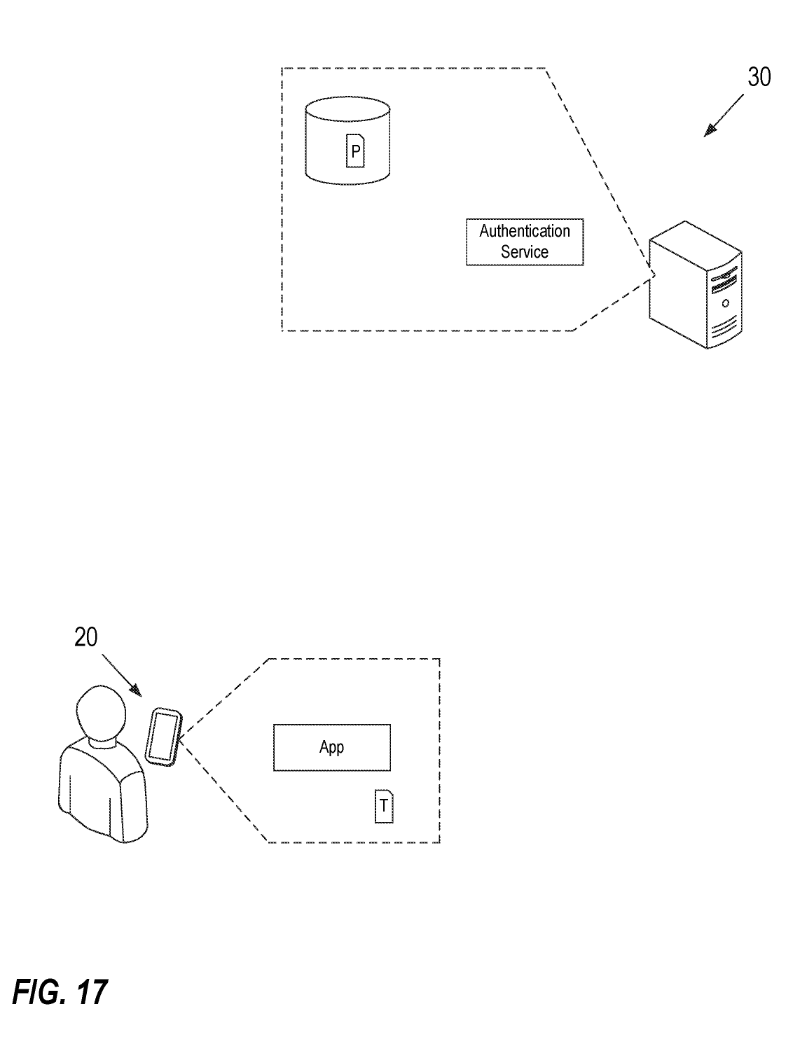

Thereafter, in accordance with one or more preferred embodiments, at step 2005, based on receipt of confirmation of successful authentication, the user is prompted to input a session passcode. At step 2006, this input session passcode is communicated to the authentication service. At step 2007, the authentication service saves the input session passcode in a secure database. At this point, the user is authenticated and is provided access to the computerized system based on the input authentication credentials and communicated authentication information. The resulting scenario is illustrated in FIG. 17.

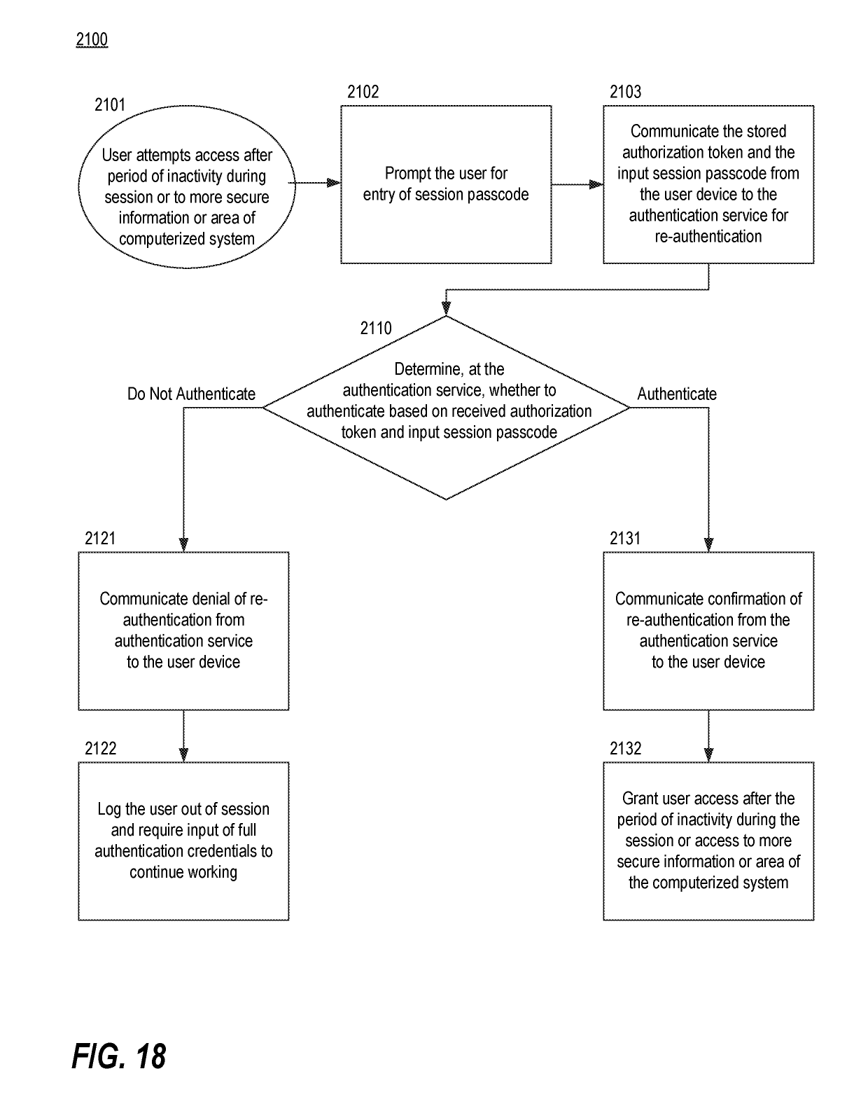

In accordance with one or more preferred embodiments, subsequently when a user attempts to access the computerized system after a period of inactivity during the session, or attempts to access more secure information or area of the computerized system, the user is prompted to enter the session passcode which is utilized in combination with the stored authorization token to re-authenticate for access. FIG. 18 illustrates an exemplary such methodology in which a user is required to re-authenticate utilizing a user-generated session passcode in conjunction with the OAuth token.

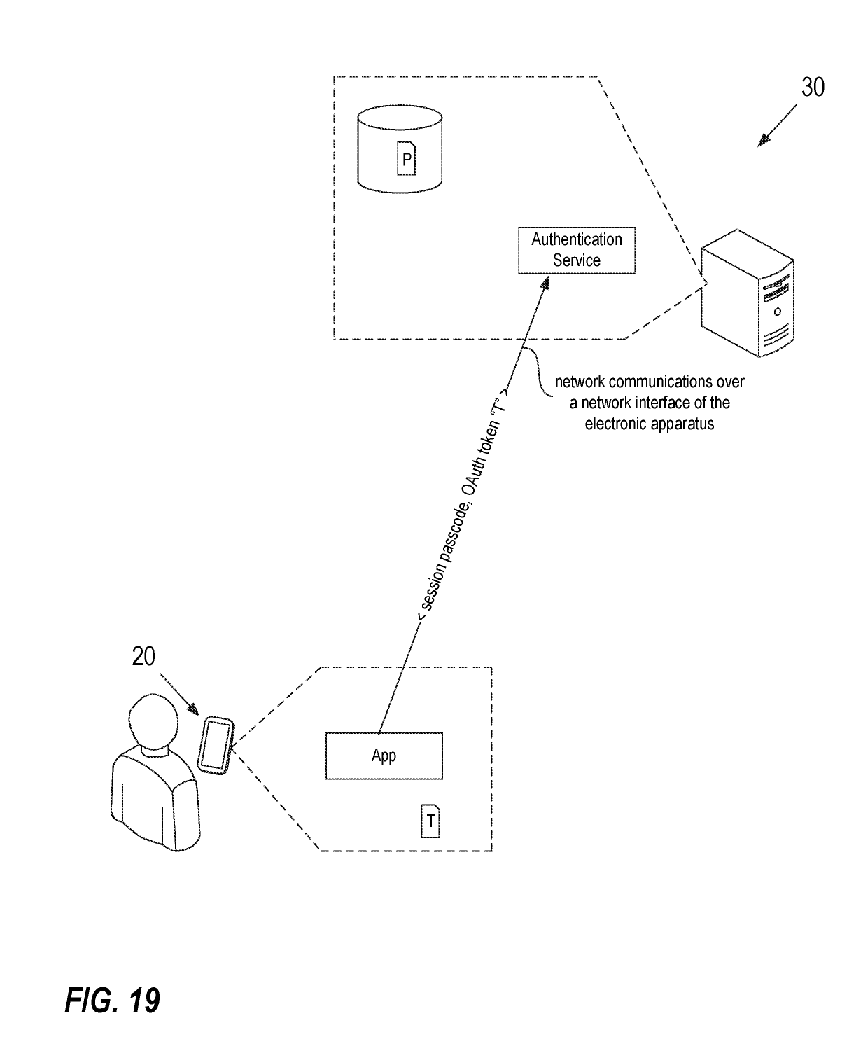

Specifically, at step 2101 the user attempts to access the computerized system after a period of inactivity during the session, or attempts to access more secure information or area of the computerized system. In response, at step 2102 the user is prompted for entry of the session passcode. At step 2103, the input session passcode and the stored authorization token each is communicated from the electronic apparatus to the authentication service for re-authentication based on each; this is illustrated in FIG. 19.

Next, at step 2110, the authentication service determines whether the received input session passcode and received authorization token are valid for re-authentication of the user. If it is determined that re-authentication is unsuccessful, then at step 2121 an indication of this is communicated from the authentication service to the electronic apparatus, and at step 2122 the user is logged out of the established session and/or prompted to enter full authentication credentials for establishing another session.

If, on the other hand, it is determined that re-authentication is successful, then at step 2131 confirmation of re-authentication is communicated from the authentication service to the electronic apparatus and at step 2132 the user is allowed the access after the period of inactivity during the established session, or the access to the more secure information and/or area of the computerized system.

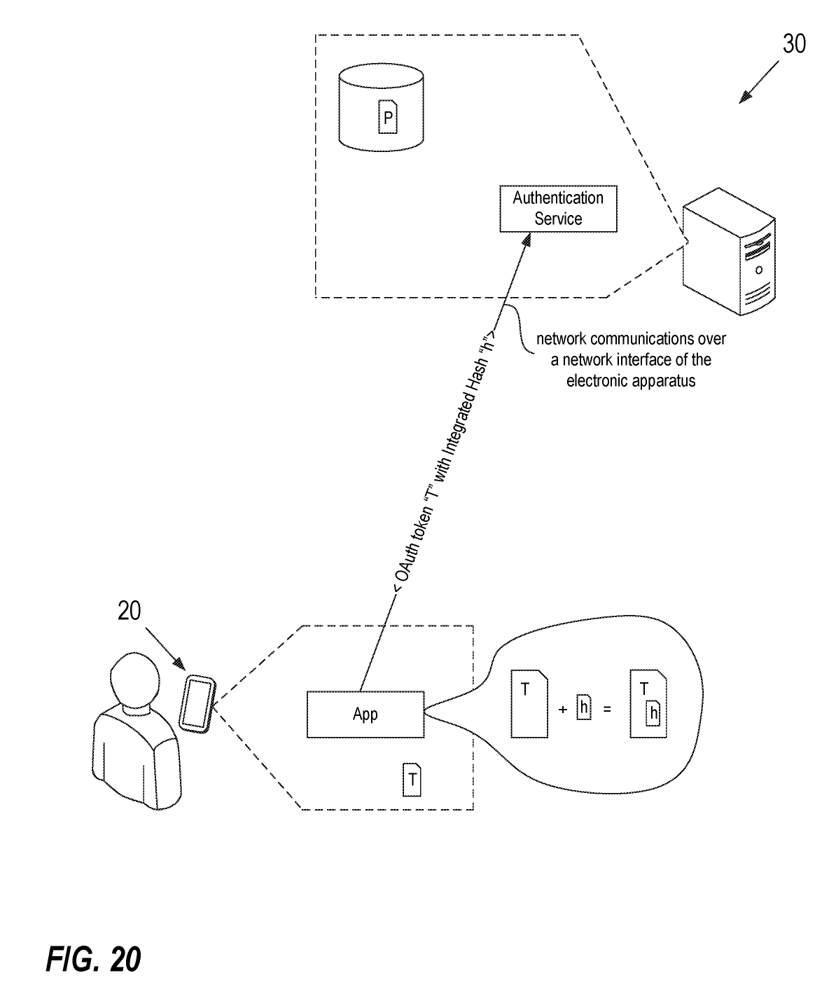

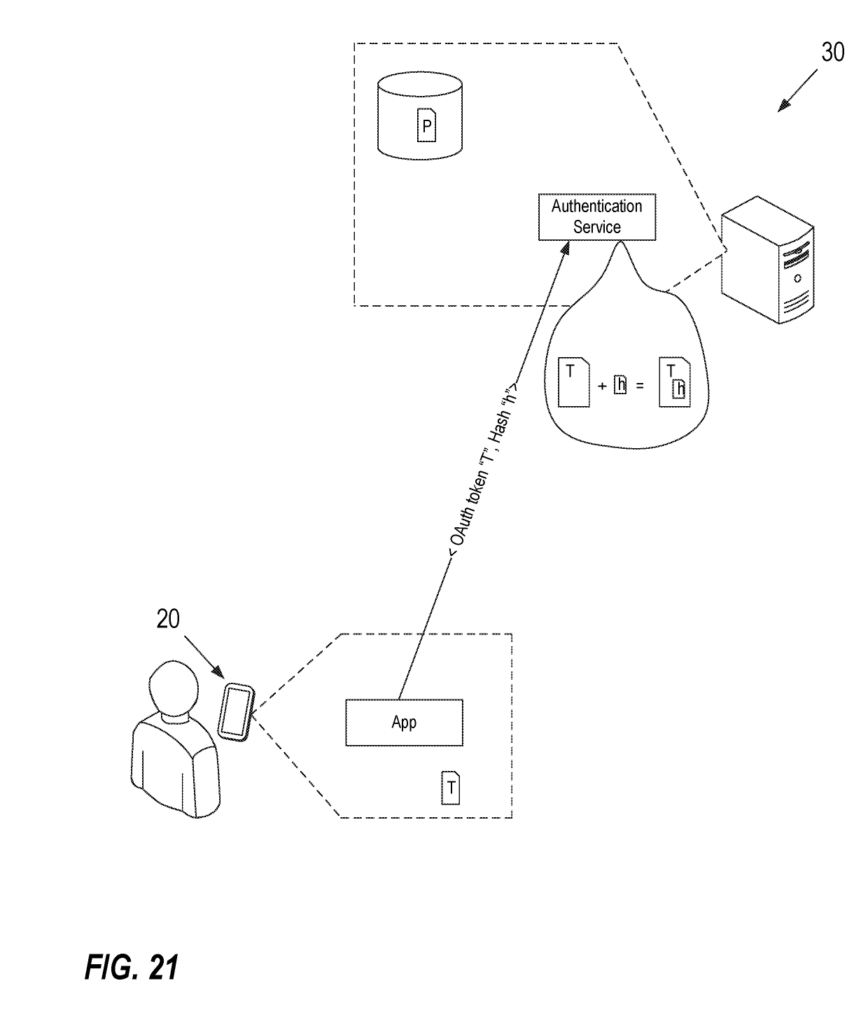

In accordance with one or more preferred embodiments, a hash of the session passcode is integrated into an authorization token at the electronic device and then communicated to the authentication service for re-authentication utilizing the stored session passcode P. This scenario is represented in FIG. 20. In a variation, the hash of the session passcode is integrated into the authorization token at the authentication service, as represented in FIG. 21.

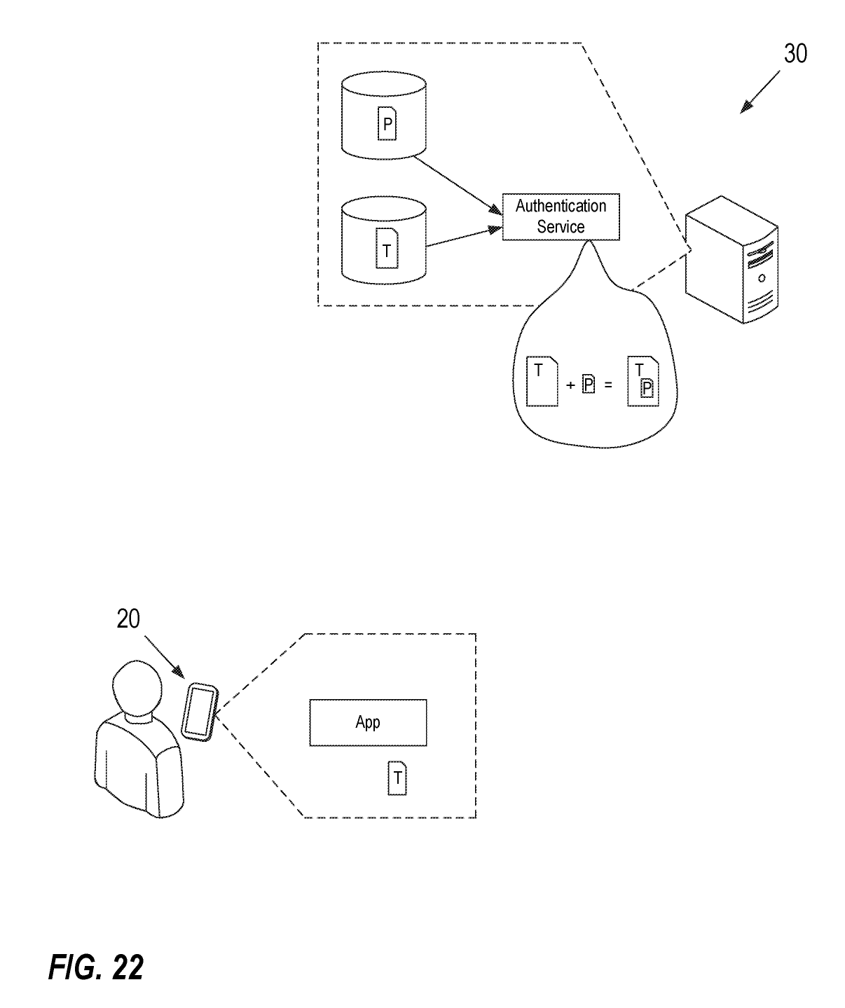

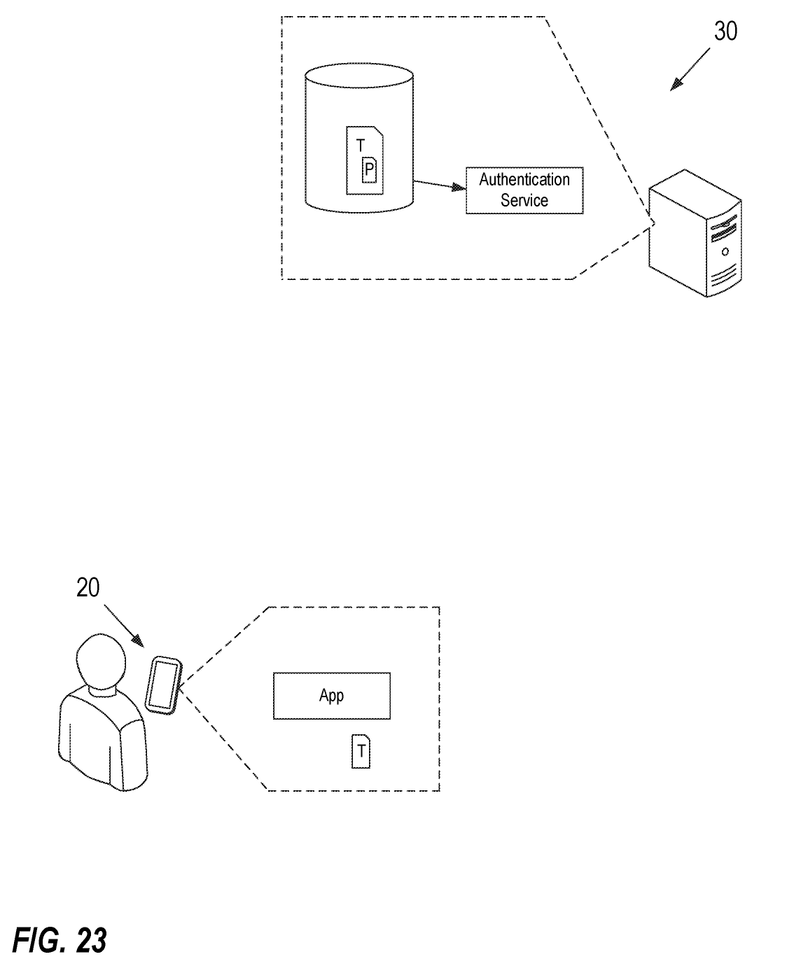

In accordance still with one or more preferred embodiments, when it is time to re-authenticate, a hash of a session passcode stored at the authentication service is integrated into an authorization token, as illustrated in FIG. 22, and the session passcode may be stored in hashed form, and/or may be hashed immediately prior to integration into an authorization token. In accordance with one or more preferred embodiments, alternatively an authorization token is stored at the authentication service with a hash of a session passcode integrated therein, as illustrated in FIG. 23.

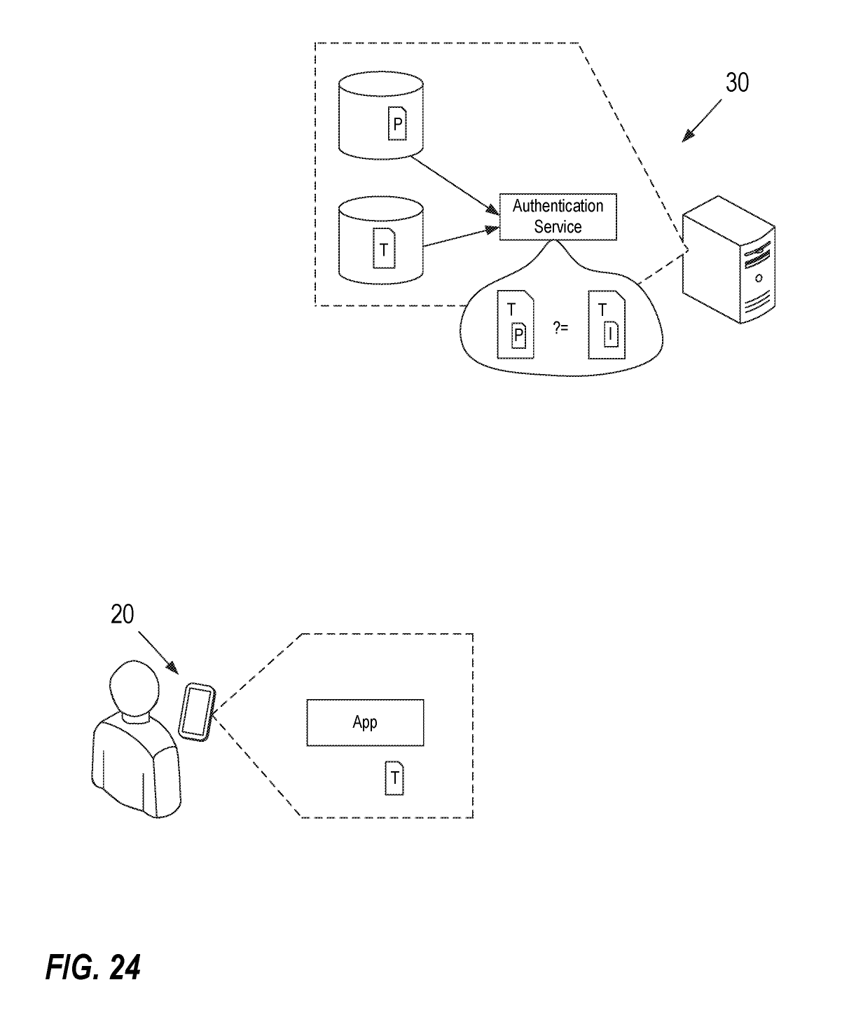

In accordance with one or more preferred embodiments, FIG. 24 generally represents an authorization token integrated with a hashed session-limited user authentication information being compared at the authentication service to an authorization token integrated with a hashed subsequent user authentication information.

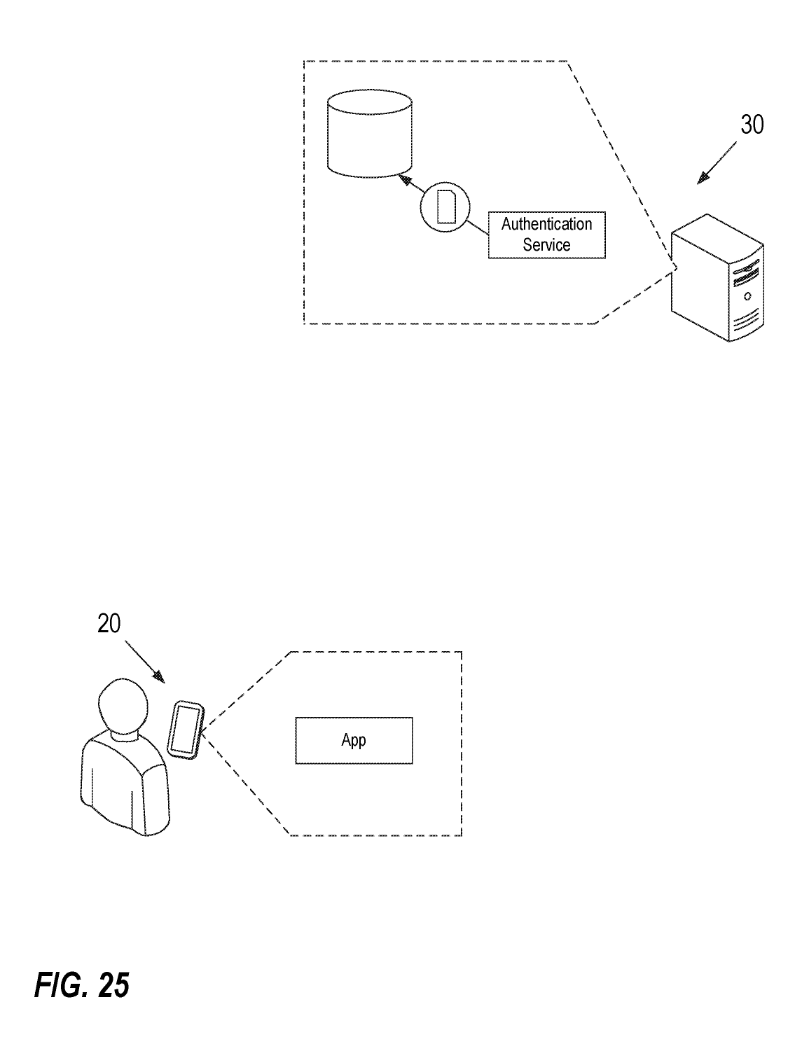

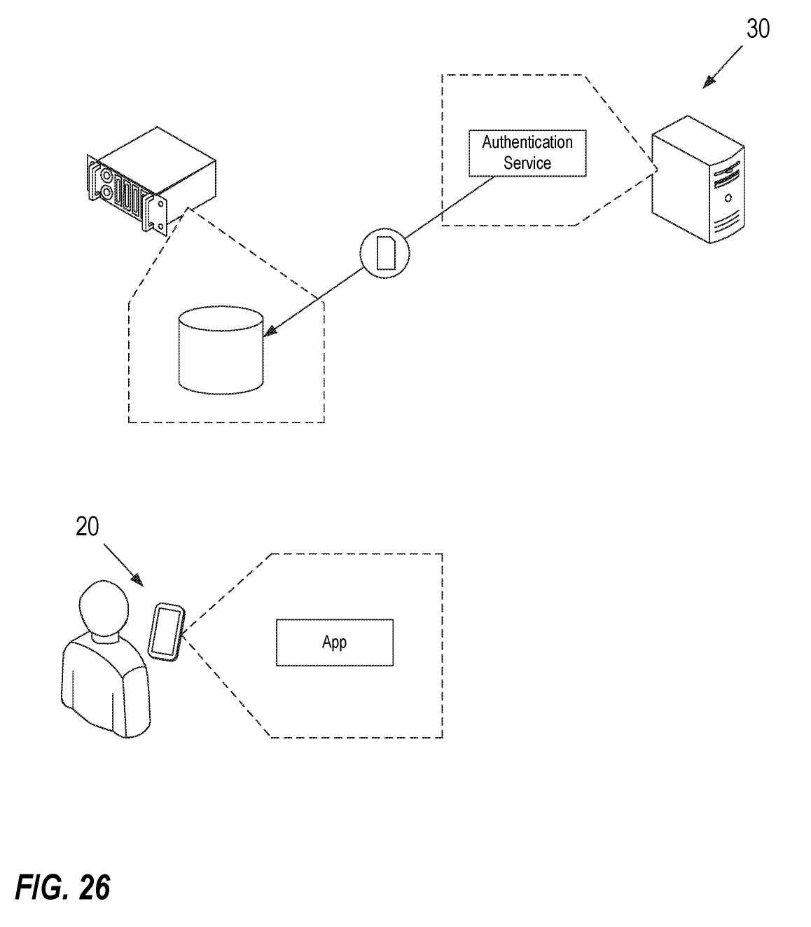

Although disclosure herein has largely illustrated an exemplary architecture in which an input session passcode is stored in a database local to an authentication service (illustrated in FIG. 25), in accordance with one or more preferred embodiments, a database or data store remote to an authentication service may be utilized to store the input session passcode for later retrieval and use by the authentication service for re-authentication during an established session (illustrated in FIG. 26).

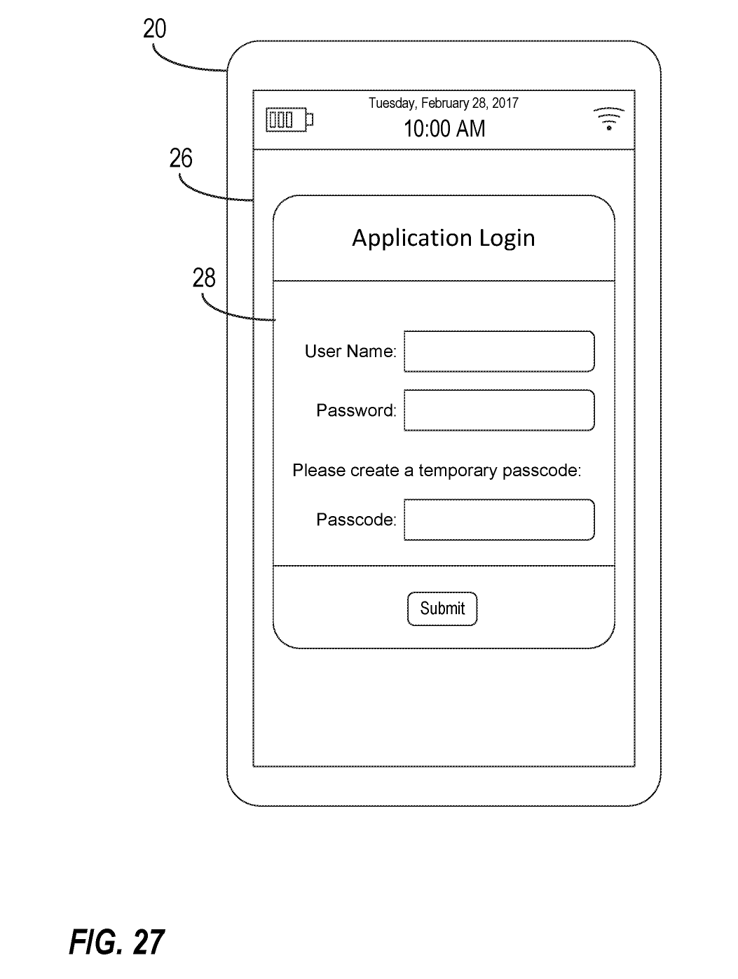

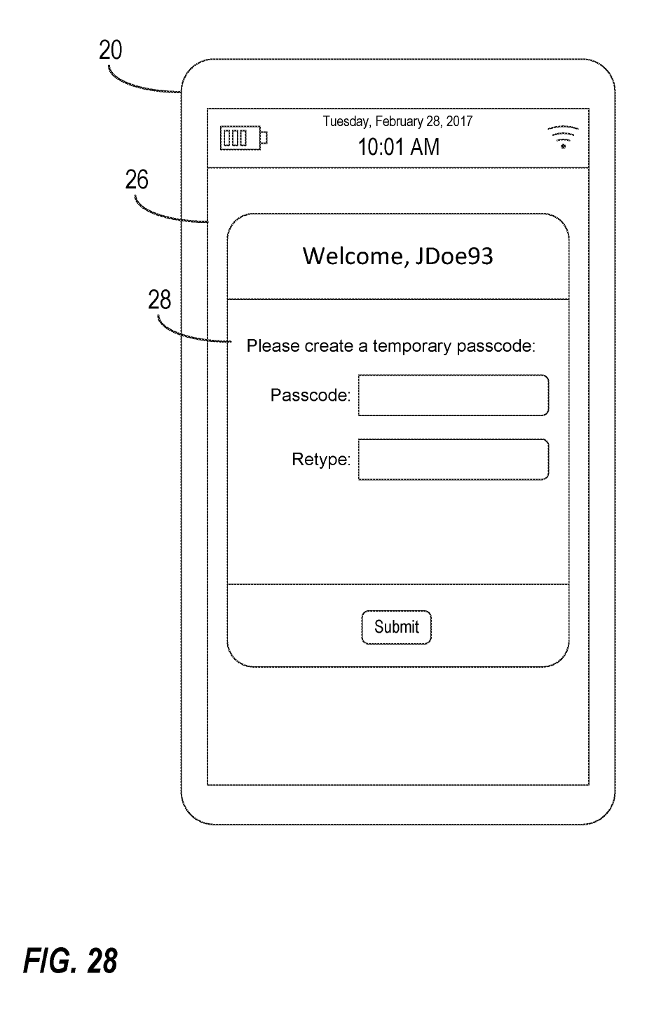

Although disclosure herein has largely focused on exemplary implementations in which a session passcode is input only after initial authorization credentials, in accordance with one or more preferred embodiments, a session passcode may be input together with authorization credentials, as illustrated in FIG. 27. Additionally, in accordance with one or more preferred embodiments, a user interface is configured to require confirmation of a user passcode for generation, as illustrated in FIG. 28.

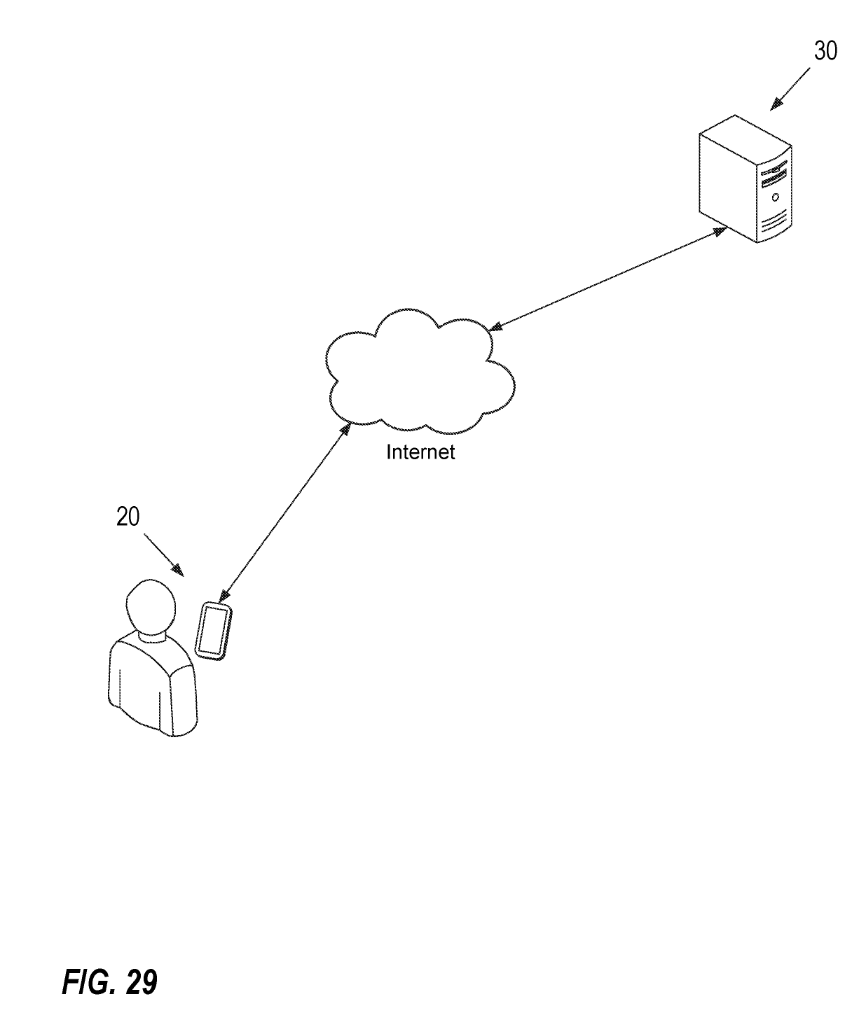

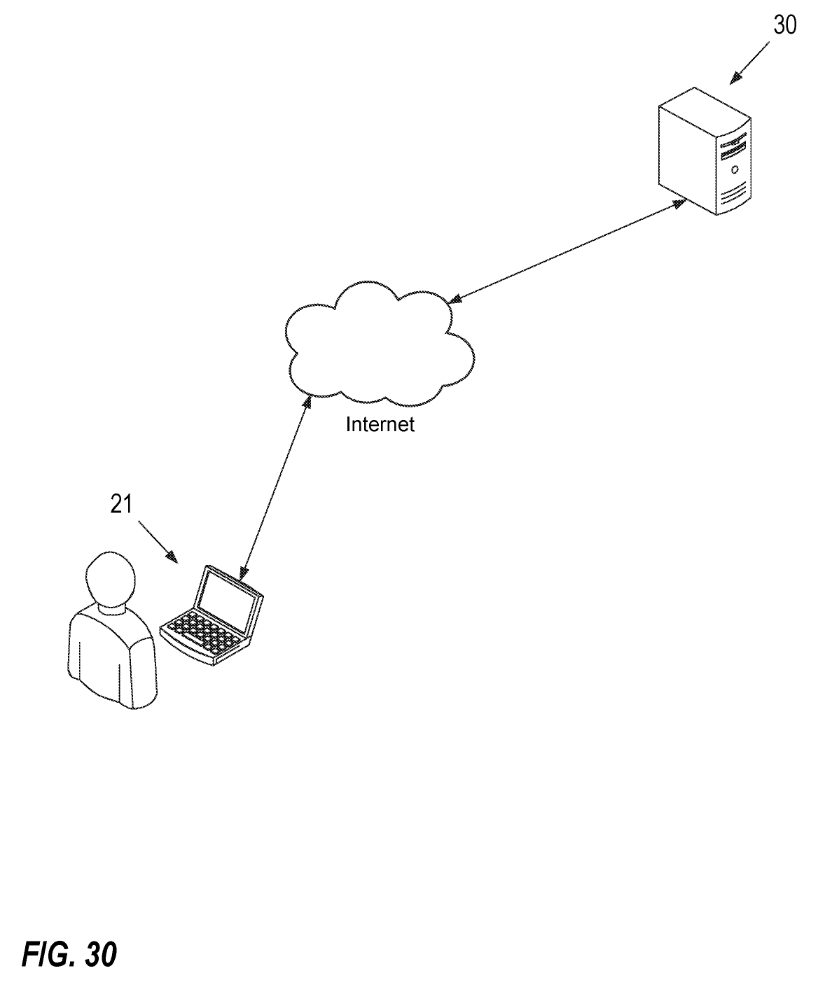

Although disclosure herein has largely illustrated an exemplary device representing a mobile computing device in the form of a smartphone 20 (as again illustrated in FIG. 29), methodologies and systems disclosed herein may be utilized with any computing device, such as a laptop computer 21 (as illustrated in FIG. 30), a desktop computer, a tablet computer, a smart watch, a slate computer, a smart appliance, etc.

In accordance with one or more preferred embodiments, a system requires the generation of a temporary passcode or other temporary authorization credentials by a human, or other autonomous entity, after normal log-in procedures are followed. As it is user-generated it can easily be remembered for the session. If it is forgotten, the user can regenerate a further temporary passcode. The extra level of security the temporary passcode confers will allow multiple advantages such as: extending the need for timeout before a full username and password needs to be entered; and/or using the temporary passcode every time a sensitive area of the computerized system is accessed.

In accordance with one or more preferred embodiments, on login, or upon token generation, a user creates a very memorable and low-complexity additional piece of information. This might be a four-digit PIN, a short word or phrase, or even a selection of a combination of a number and color or a picture from a list.

In accordance with one or more preferred embodiments, once a user has logged in, a system will not keep asking the user for his or her relatively complex authentication details, but when the user wants to add or view sensitive information or stay in the system for longer the user must provide the short PIN/phrase/select the correct listed items. If the user gets it wrong a defined number of times (from one upwards), the user is logged out.

In accordance with one or more preferred embodiments, a session passcode or temporary authorization credentials are stored in temporary storage inside a computer access system, in a protected database, and not kept in any cookies or session variables that might be accessible to a hacker. On log out, or token expiry, or at the end of a predefined time or number of sessions, the session passcode or temporary credentials are destroyed. In one or more preferred embodiments, a session passcode or temporary credentials could be kept for a period to prevent a user from choosing the same session passcode or temporary credentials repeatedly. Preferably, for high security systems, every time a user logs in, her or she chooses a new session passcode or temporary credentials. Preferably, a user will not need to write temporary credentials down in order to remember the temporary credentials as they were very recently chosen. Moreover, if the temporary credentials are written down, they will become useless to an attacker following the established session to which they relate.

In accordance with one or more preferred embodiments, when a token is generated, a hash of a session passcode is stored with it. Subsequently, the token cannot be used without the correct session passcode, so even if the token is stolen so that a hacker can access the system in general, as soon as the hacker tries and fails to access any user data (not knowing the session passcode), the hacker will be locked out and the token will be revoked. In accordance with one or more preferred embodiments, three or less attempts are allowed to prevent brute force attackers from “cracking” the session passcode. Provided that a user is not permitted to choose runs of numbers (e.g., 1234), repeated numbers (e.g., 0000), or dictionary words (e.g., pencil), it is believed that it will be very hard for a hacker to successfully attack the system.

Methodologies in accordance with one or more preferred embodiments serve to protect a user in the case that he or she wanders off leaving his or her terminal logged in; serve to protect a user against having an authorization token stolen (e.g., hacked); and obviate the requirement for a user to remember or maintain additional authorization information for an extended period of time, which need to maintain additional information for an extended period of time might cause the user to write down the additional information.

In accordance with one or more preferred embodiments, systems and methodologies disclosed herein are combined with clear education to users regarding the selection of passwords that are long with a range of characters which can be easily remembered and never written down (e.g., my_18_little-blue*horse—very nearly as hard for a computer to crack as a random string of the same length but without the downside of needing to write it down. In accordance with one or more preferred embodiments, methodologies are fast enough as to not disrupt a user's workflow too much whilst protecting against unauthorized access.

In accordance with one or more preferred embodiments, password education involves informing users not to use a bank card PIN, not to repeat a session passcode, and to use a password that can be remembered without it being written down, and which the user does not and will not use for other systems. In accordance with one or more preferred embodiments, a system may be configured to offer a selection of randomly generated memorable passwords for inspiration, together with an instruction to change at least one element of the randomly generated password. Exemplary randomly generated passwords may comprise sets of colors, letters, numbers, and special characters mixed with dictionary words.

In accordance with one or more preferred embodiments, a user generates a single session passcode after normal authentication protocols have been used to access a system. This single session passcode can be used for the rest of the session to allow the user to access sensitive data or areas within the system, without requiring a repeat of the same authentication. It is believed that this solves problems associated with a user having to repeatedly authenticate himself or herself for access in a computerized system. It allows the user to generate his or her own passcode for every session avoiding the need to remember multiple passcodes. It also allows for the user to spend longer time in less sensitive areas of a system before a sensitive-authentication time out which is generally defined by the most sensitive areas of a system. It also provides an auditing layer that records when a user has accessed a sensitive area in a system. This methodology improves workflow, security, and audit of use within systems that have internal differential security sensitivities.

In accordance with one or more preferred embodiments, a user who generates temporary authorization credentials may be any autonomous agent including a person, animal, or artificially intelligent entity. In accordance with one or more preferred embodiments, a user authenticates with a secure system in a manner that can range from static single factor authentication to a combination of static and dynamic multifactor authentication.

This authentication can include, for example: a username and password; biometric authentication including facial recognition, fingerprint scanning, ear scanning, retinal scanning, electrocardiogram analysis, pulse analysis, and gait analysis; a dynamic session limited computer generated passcode using cryptography or other techniques; authentication by another user who is physically local (e.g., authentication by a person who supports a user with a learning disability before the user accesses a sensitive system either for assessment or for work, for example the other person could log onto the system, validate the user and then leave the user to generate a session passcode); authentication by another user who is remote (e.g., this could be done through video link where a remote person logs into the system and verifies the user by video link and logs them into the system where they are prompted to create a session passcode).

In any scenario, following initial authentication, in accordance with one or more preferred embodiments, a user is prompted to generate one or more temporary authorization credentials. The form of such temporary authorization credentials can vary depending on system security requirements and user abilities.

In accordance with one or more preferred embodiments, a system is configured to prompt a user to: generate a four-to-six digit PIN that the user will use to reauthenticate himself or herself for the rest of the session; generate a four-to-eight character word that the user will use to reauthenticate himself or herself for the rest of the session; choose a number of presented images (e.g., between two and four) that the user will use as his or her passcode for the rest of the session (this could be useful for people with cognitive impairment who may choose images of people they know or objects that are familiar to them); say a word or number sequence that the user will use to reauthenticate himself or herself for the rest of the session (this might, for example, combine voice recognition and the passcode or facial, voice, and passcode recognition); say “hello”, which will be the user's passcode for the rest of the session (this method might provide a simple word at random from a pre-defined library, which could be useful for people with cognitive impairment); or answer a question that will then be asked again later (e.g., the system queries what the user had for breakfast; this question can be a question from a library of predefined questions, with voice and/or text input into the system).

Other methodologies may be utilized as well. In accordance with one or more preferred embodiments, a passcode is comprised of a series of facial expressions.

In accordance with one or more preferred embodiments, a user is initially presented with a variety of options for creating a passcode that might, for example, include the examples described above. This would add a further layer of complexity to anyone trying to hack the system.

In accordance with one or more preferred embodiments, a methodology might involve any combination or permutation of the above.

In accordance with one or more preferred embodiments, a passcode is generated by a user's preference for presented options, some of which may be fixed and some of which may change over time. This is useful for users with limited or diminished cognitive abilities. This could even be utilized, for example, for an animal for granting access to entering a compound. Different animals are likely to have different food preferences, and access to a compound or a particular area of a compound may be gated by switches that are activated through consumption of certain food sources. Consumption of a certain food source or a certain combination of food sources may enable access to the compound or area of the compound. This may allow access to certain animals while preventing access by certain predators (or even poachers) that would not necessarily choose the same food source or combination of food sources. In accordance with one or more preferred embodiments, presented food may be destroyed afterwards so that a predator or poacher could not learn a pattern of selection.

In accordance with one or more preferred embodiments, a system can be configured to check whether input for use as one or more temporary authorization credentials is the same as previously utilized temporary authorization credentials, and disallow repeated use of the same temporary authorization credentials. For variable system security, this could be set to the last “x” number of utilized temporary credentials or all previous temporary credentials.

In accordance with one or more preferred embodiments, if input desired temporary authorization credentials are the same as previous temporary authorization credentials and this is not allowed, then a user will be prompted to input or generate different temporary authorization credentials.

Preferably, once acceptable temporary authorization credentials have been generated, they will be stored in a secure database separate from other security related elements.

In accordance with one or more preferred embodiments, such a database can be either associated with an account or it can be localized, such as on a user's device. For example, in the case of using a mobile app to access data, the app may have securely stored data or downloaded sensitive data from a central server. In accordance with one or more preferred embodiments, in order to view this data or upload it to the server, temporary authorization credentials such as a session passcode is required. This prevents a person who has stolen or borrowed the device from using it to interfere with sensitive personal information, without forcing the user to continually log in and out of the app (which would form a barrier to use).

In accordance with one or more preferred embodiments, a system owner or administrator can define when there is a requirement for temporary authorization credentials to be used.

In accordance with one or more preferred embodiments, temporary authorization credentials are used for rapid access when a system is going to time out. In an exemplary implementation, a system which would normally time out after five minutes of inactivity is instead set to time out after sixty seconds of inactivity allowing a user up to four hours to put in their temporary authorization credentials. This both increases security by decreasing the window for potential unauthorized intruder access whilst allowing a user to easily revalidate on the system a long time after the normal time out.

In accordance with one or more preferred embodiments, it is possible to shorten the amount of time that a sensitive page is open and visible. If the user is in a sensitive area, temporary authorization credentials can be set to be required on much shorter periods of inactivity, or a system may be set to require temporary authorization credentials regardless of the level of activity, or based on certain types of user behavior (repeated data requests or multiple data uploads for instance). Different sorts of data access (or data creation) can have their temporary authorization credential criteria specified differently.

Furthermore, the entry of temporary authorization credentials provides an auditable record of when a user accesses each sensitive area on the system.

In accordance with one or more preferred embodiments, temporary authorization credentials are utilized for rapid access to more sensitive areas of a system. In an exemplary implementation, a user who has been using a system as normal wants to access more sensitive information and is prompted for his or her temporary authorization credentials. The user provides his or her temporary authorization credentials and gains access to the more sensitive information. This provides a further level of system security. For instance, if an unauthorized person gained access to the system in the sixty seconds from last use when the normal prompt for temporary authorization credentials was required, the person still would not be able to access the sensitive materials without entering the temporary authorization credentials. Furthermore, the entry of the temporary authorization credentials facilitates an auditable record of when a user accesses a sensitive area of the system.

Many systems allow remote access via encrypted authentication tokens. There is a security risk in the use of tokens, as if they are intercepted or stolen they can be used by another party to access user data up until the point at which they expire. Secure systems require short expiry times, after which the user has to refresh their token.

In accordance with one or more preferred embodiments, to add further security, temporary authorization credentials may be combined with a session token or authorization token (e.g., an OAuth token), where neither is a valid way of authenticating a user without the other. In this way, even if a token was stolen, an unauthorized user would not be able to access the system.

In accordance with one or more preferred embodiments, temporary authorization credentials are hashed and integrated into a session token or a decryption key in an obfuscated way. Utilizing this methodology would mean that the temporary authorization credentials could not be recovered if the token/key was stolen. To check the validity of the temporary authorization credentials on further logins, the temporary authorization credentials are hashed using the identical methodology to the original temporary authorization credentials and session token integration. The characters would then be compared in the combined temporary authorization credentials and original session token to allow the user to continue access or to access the sensitive area if they match.

In accordance with one or more preferred embodiments, hashing/obfuscation of temporary authorization credentials can occur at a computerized system (e.g., at an authentication service of the computerized system), in which case an encrypted application programming interface (API) call to the computerized system (e.g., a server or service) is required to check that the temporary authorization credentials entered by the user at the electronic apparatus (or user system) matched the token. This could occur either at the start of the interaction (after which the temporary authorization credentials could be temporarily held in memory on the device in a secure way if needed) or with each temporary authorization credentials-required access depending on the use case. A repeated API call is a secure way to access a system if the electronic apparatus storage itself is not very secure, as it prevents the temporary authorization credentials from needing to be being stored on the electronic apparatus (or user system) at all.

Alternatively, the hashing/obfuscation could happen at an electronic apparatus. In this case, the hashed temporary authorization credentials are sent to the computerized system, which would generate an authentication token, with the hashed version of the temporary authorization credentials attached in some way (appended, prepended, inserted, or interleaved) and returned to the device. This allows authentication using the temporary authorization credentials to happen entirely on an electronic apparatus. The temporary authorization credentials are not stored at the computerized system, and if the token is transferred to another device then even if the user knows the temporary authorization credentials, authentication will still fail. This ties the access to the device itself.

In accordance with one or more preferred embodiments, the number of times temporary authorization credentials can be incorrectly entered before complete logout could be limited from one upwards. This would further enhance security and effectively neutralize the risk of a brute force attack guessing the temporary authorization credentials.

In accordance with one or more preferred embodiments, after log out, a user must log in again using their primary, more secure access methodology (such as username and password) before generating new temporary authorization credentials. In accordance with one or more preferred embodiments, it is possible to store “used” temporary authorization credentials for each user and bar users from re-using older temporary authorization credentials forever, or for a certain period of time, in order to increase security.

In accordance with one or more preferred embodiments, following login to an application via an electronic apparatus, a user is prompted to input temporary authorization credentials, e.g., a session passcode. In accordance with one or more preferred embodiments, a hash of these temporary authorization credentials is securely stored. This could be stored locally at the electronic apparatus in the same file system, locally in a different file system, virtually at the electronic apparatus, locally on a different virtual machine at the electronic apparatus, in a cloud, at a remote server, at an electronic access system, at a remote data store, at a physically proximate device, etc. Subsequently, upon a triggering event, a user of the electronic apparatus will be prompted for input of the temporary authorization credentials. These input temporary authorization credentials will be hashed in the same manner as the original temporary authorization credentials, and the hashes will be compared. If there is a match, the user is re-authenticated. In this way, access to an application is gated by the session passcode. If a user is unable to re-enter the correct session passcode, then full re-login will be required.

In accordance with one or more preferred embodiments, following login to an application associated with a computerized system via an electronic apparatus, an authorization token is returned to the electronic apparatus and stored at the electronic apparatus, and a user is prompted to input temporary authorization credentials, e.g., a session passcode. In accordance with one or more preferred embodiments, these temporary authorization credentials or a hash of these temporary authorization credentials are communicated to the computerized system. The temporary authorization credentials, or a hash thereof, or an integrated token containing the temporary authorization credentials or a hash thereof, are stored at the computerized system. Subsequently, upon a triggering event, a user of the electronic apparatus will be prompted for input of the temporary authorization credentials. These input temporary authorization credentials will be hashed and integrated into the authorization token stored at the electronic apparatus. The integrated authorization token will be communicated from the electronic apparatus to the computerized system where it is compared to an integrated token integrating the previously communicated session passcode or hashed session passcode. If there is a match, the user is re-authenticated. In this way, access to an application is gated by the session passcode. If a user is unable to re-enter the correct session passcode, then full re-login will be required.

In accordance with one or more preferred embodiments, in a decryption key context, systems and methods disclosed herein are utilized to partially solve issues with contemporary offline security of devices that store sensitive information. Current systems that need offline secure information typically need to have both the decryption key and the encrypted data stored on the same devices. Even when these are in separate file areas, an experienced hacker is often able to access the decryption key and hence is able to unlock the encrypted data. In accordance with one or more preferred embodiments, adding a further step which is changed per user access, and can potentially be held in memory for the duration of the session, further increases the barriers for a hacker to access personal information.

In accordance with one or more preferred embodiments, following login to a computerized system or application via an electronic apparatus or access of data within the computerized system or application, a user is prompted to input temporary authorization credentials, e.g., a session passcode. In accordance with one or more preferred embodiments, a hash of these temporary authorization credentials is utilized to encrypt data for the computerized system or application, where a decryption key is generated which is incomplete in that it needs the session passcode or a hash of the session passcode inserted in order to be complete. Subsequently, if a user wants to access the encrypted data, the user will be prompted for input of the temporary authorization credentials. These input temporary authorization credentials will be hashed in the same manner as the original temporary authorization credentials, and the hashes will be compared. If there is a match, the user is re-authenticated. In this way, access to data from a computerized system or application is gated by the session passcode. If a user is unable to re-enter the correct session passcode, then full re-login will be required.

In accordance with one or more preferred embodiments, at the termination of a session, temporary authorization credentials are destroyed from a temporary authentication database and the temporary authorization credentials are archived where they could, depending on security preferences as defined above, be used to ensure temporary authorization credentials, or elements of temporary authorization credentials (similarities), are not repeated, or only able to be repeated after a set time period.

In accordance with one or more preferred embodiments involving lower security requirements on the system and a need for increased usability, temporary authorization credentials may survive for more than one session on a physical computer. In this situation, the user has finished the session through either logging out or timing out. The temporary authorization credentials are preserved and on login the user is presented with two options which is to either log in as the last user with the temporary authorization credentials or standard log in, requiring the normal authentication process for the system. This embodiment does not have the same security as the previous embodiments; however, it does provide a very convenient way for a user to access the system. As soon as a different user logs into the same physical computer, the temporary authorization credentials associated with the previous user are destroyed.

In accordance with one or more preferred embodiments for even less secure systems, temporary authorization credentials are preserved for several users of a system for variable amounts of time or sessions or conditions. The persistence of the temporary authorization credentials will always be limited depending on the system configuration.

In accordance with one or more preferred embodiments, temporary authorization credentials or a session limited passcode are utilized for generation of a decryption key and/or an encryption key. In accordance with one or more preferred embodiments, data is encrypted by a computerized system before communication to an electronic apparatus, and the temporary authorization credentials or session limited passcode for a user of the electronic apparatus can be utilized for generation of a decryption key for decryption of the communicated encrypted data.

Although sometimes described herein in the context of applications, in accordance with one or more preferred embodiments a web application or web page or other resource is configured to utilize or is utilized in systems and methodologies disclosed herein.

An exemplary use case in accordance with one or more preferred embodiments will now be described with reference to an exemplary user, Mark.

Mark left school before attaining any formal qualifications as he found studying very difficult because he had a decreased capacity compared to his peers for learning. He started working in a care home as a cleaner. After eighteen months, Mark made an internal shift in the organization as a caregiver's assistant. Another two years later he was promoted to being a caregiver. As a caregiver, Mark was required to access the care home computer system to make notes and record medication usage by the residents of the care home. As this was a secure system that could access the personal details of several residents, a twelve character, unique passcode of combined alphanumeric characters and symbols was required to access this. Also, due to security requirements, the system timed out after five minutes of not using it. As Mark had a poor memory, his passcode was written down and stored in a locked cabinet with him and his supervisor being the only people with the key. Due to the time out and being busy with tasks, Mark would have to retrieve the passcode from the cabinet several times a day. This increased the risk of Mark forgetting to put the passcode back in the cabinet and took considerable time out of Mark's working day.

A session-limited user passcode system was implemented into the computer system at the care home Mark worked at. Mark generated a session-limited user passcode every day that was based off easy to remember things known by him such as his dinner breakfast combination with either the date or the number of people he had been looking after. Mark was required to enter his session-limited user passcode every sixty seconds after inactivity. Due to this extra layer of security, the time out on the normal authentication was increased to four hours. Mark occasionally forgot his session-limited passcode but overall it saved roughly forty-five minutes a day, and improved both the system security and Mark's job satisfaction.

The above example could be modified for the use case for any person who is required to access a sensitive area, either physical or virtual, during their day to day activities. One or more preferred embodiments could be utilized in any industry or area, including, by way of non-limiting example, banking, finance, government, military, education, energy, healthcare, legal, law enforcement, research and development, and transport.

Although described herein largely in the context of electronic systems or platforms, and in the context of implementations in which passcodes, databases, and storage are implemented using electronic computing hardware, in accordance with one or more preferred embodiments, systems and methodologies disclosed herein are implemented on a physical or biological system using either locked storage or memory for the storage, retrieval and cross-checking of user generated passcodes or temporary authorization credentials.

In addition to the foregoing, and in an extension of the use and benefit of one or more preferred embodiment disclosed above, it is noted that with the increase in the use of apps on mobile devices there is a need for storing sensitive data on these devices, which sensitive data may need to be accessed when these devices are offline. If the sensitive information is encrypted then there will also need to be a decryption key which is also offline. It is obviously not an ideal situation when the decryption key and the encrypted information is on the same device as if the device is compromised an attacker would be able to gain access to both files and “crack the information”. Methods such as storing the components in different folders have been used, and recommending users lock their devices with appropriate authentication barriers; however, there is still an ongoing need to improve the security arrangements around sensitive information on devices which may be temporarily offline. Within this context, it is believed that the combination of a biometric signature and user-generated, session-limited user authentication information can be used to enhance the security, wherein the nature of the combination is hidden through storing the different security components in different areas where they would be hashed.

Additionally, it is preferred that the user-generated, session-limited user authentication information for certain sensitive data only be accessible for the battery life of the device or for a certain time period. This is based on the assumption that if the battery were charged then the user would likely have access to the Internet. The other method would be a combination of a time limit or access to the Internet. An example of this would be the secure data could only be locked with specific user-generated, session-limited user authentication information that was less than 4 hours old, assuming there was Internet or other physically separated access. If there was no Internet access for 8 hours (a normal working day), then the user-generated, session-limited user authentication information could still be used. As soon as there was internet connectivity or other connectivity to a remote authentication capability such as a server or paired device (might be a laptop) then there would be the requirement for the user-generation of new session-limited user authentication information.

If someone were working offline and had the SLP generation facility on his or her laptop and used his or her phone for most of the data access, then after a while certain secure elements of the phone would be locked down as the SLP would expire; however, when the person then physically or otherwise (NFP, Bluetooth) connected to the laptop, then a new SLP could be generated. This method could be used for SLP generation for a certain period of time which could be predetermined. For instance, if we knew the worker was going to be away from internet connectivity for a fixed period of time such as a week, then after a week the SLP would only be able to be generated if the laptop and/or the phone had been authenticated through a server via the Internet. To build-in even more robustness the nature of the connection could be defined. For instance, only connection through a certain device or method such as a particular WiFi hub or broadband connectivity at a certain location, such as a hospital or military base.

The above provides a chain of complexity at the backend that increases the security so that when a device is compromised the attacker needs to have access to all files on the device, know how they work, be able to have a biometric signature and the SLP and be able to complete it in a way that is time limited, thereby drastically decreasing the chance of compromise on remote and/or mobile devices. Meanwhile it does this through minimally impacting the experience of the authorized user.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A method for granting access by a user to a computerized system, comprising the steps of:
(a) first, authenticating the user for granting access to the computerized system based on initial user authentication information; and
(b) every time upon a successful authentication performed in said step (a),
(i) establishing a session, during which the user is granted the access to the computerized system,
(ii) saving a resultant based on session-limited user authentication information
(A) which session-limited user authentication information is manually-entered by the user after the successful authentication performed in said step (a), and
(B) which session-limited user authentication information is different from the initial user authentication information on which is based the successful authentication performed in said step (a), and
(iii) using the saved resultant, during the established session, for authenticating the user for granting subsequent access during the session based on subsequent user authentication information that is manually entered.

2-6. (canceled)

7. The method of claim 1, wherein the subsequent access granted in said step (b) (iii) is access to the computerized system during the session that is subsequent to a predefined dormant time period in which there is no activity by the user.

8. The method of claim 7, wherein the session has an expiration time period after which a new session must be established using the initial user authentication information; and wherein the predefined dormant time period is less than the expiration time period.

9. The method of claim 1, wherein the subsequent access in said step (b) (iii) comprises extending a time period of the established session during which access to the computerized system is granted.

10. The method of claim 1, wherein the subsequent access in said step (b) (iii) is access to a sensitive area of the computerized system during the established session that is subsequent to the user already having been granted and having access to other areas of the computerized system when step (b) (iii) is performed.

11. The method of claim 10, wherein every time step (b) (iii) is performed in authenticating the user for granting access to the sensitive area of the computerized system, the computerized system creates an entry in a log for use in later auditing access to the sensitive area by that user.

12. The method of claim 1, wherein each of the initial user authentication information and the session-limited user authentication information is provided by the user; and wherein security requirements for the initial user authentication information are stricter than security requirements for the session-limited user authentication information, whereby the initial user authentication information is harder to successfully brute force attack than the session-limited user authentication information.

13-28. (canceled)

29. The method of claim 1, further comprising using the session-limited user authentication information only during the established session for authenticating the user for the subsequent access in said step (b) (iii).

30-104. (canceled)

105. A method, comprising:
(a) a step for authenticating a user based on initial user authentication information; and
(b) steps for, every time upon a successful authentication,
(i) establishing a session, during which the user is granted access to a computerized system;
(ii) saving a resultant based on session-limited user authentication information;
(iii) using the saved resultant, during the established session, for authenticating the user for granting subsequent access by the user during the established session based on subsequent user authentication information that is manually entered; and
(iv) for restricting the session-limited user authentication information to something that is different from the initial user authentication information.

106-109. (canceled)

110. A method for granting access by a user to a computerized system comprising, authenticating the user based on initial user authentication information; and following a successful initial authentication for granting the user access to the computerized system both saving a resultant based on session-limited user authentication information that is entered by the user, and using the saved resultant for authenticating the user for granting subsequent access by the user based on subsequent user authentication information that is manually entered, wherein the session-limited user authentication information is different from the initial user authentication information on which is based the successful authentication that is first performed.

111. The method of claim 110, wherein the session-limited user authentication information is manually entered by the user.

112. The method of claim 110, wherein the session-limited user authentication information is manually-entered by the user after the successful authentication that is first performed.

113. The method of claim 110, wherein the session-limited user authentication information is manually entered by the user following the successful initial authentication.

114. The method of claim 110, wherein the session-limited user authentication information is manually entered by the user immediately after the successful initial authentication.

115. The method of claim 110, wherein the session-limited user authentication information is manually entered by the user with entry of the initial user authentication information.

116. The method of claim 110, wherein the session-limited user authentication information is not entered by the user before the initial user authentication information is entered.

117. The method of claim 110, wherein each subsequent access corresponds to a new session during which user access is granted based on the initial user authentication information, and wherein the saved resultant is used for a predetermined number of such sessions, whereby the session-limited user authentication information on which the saved resultant is based is limited to such sessions.

118. The method of claim 110, wherein each subsequent access corresponds to a new session during which user access is granted, and wherein the saved resultant is used for a predetermined period of time following the initial successful authentication, whereby the session-limited user authentication information on which the saved resultant is based is limited to use for establishing sessions within such predetermined period of time.

119. The method of claim 110, wherein each subsequent access continues a session during which user access is granted, whereby the session-limited user authentication information on which the saved resultant is based is limited to such session.

120. The method of claim 110, wherein a subsequent access expands the access that is granted during a session, and wherein the saved resultant is used for such session, whereby the session-limited user authentication information on which the saved resultant is based is limited to such session.

121-123. (canceled)
